(19) United States
(12) Patent Application Publication
(10) Pub. No.: US 2025/0272853 A1
(43) Pub. Date: Aug. 28, 2025

(54) FLOW-BASED FEATURE PROPAGATION WITH RANGE EXPANSION WARPING

(71) Applicant: QUALCOMM Incorporated, San Diego, CA (US)

(72) Inventors: Jamie Menjay LIN, San Diego, CA (US); Jisoo JEONG, San Diego, CA (US); Fatih Murat PORIKLI, San Diego, CA (US); Kai WANG, San Diego, CA (US)

(21) Appl. No.: 18/588,949

(22) Filed: Feb. 27, 2024

(51) Int. Cl. G06T 7/246; G06T 3/18; G06T 11/00

(52) U.S. Cl. CPC G06T 7/248; G06T 3/18; G06T 11/00; G06T 2207/20228

(57) ABSTRACT

Systems and techniques are provided for feature propagation. A process can include obtaining flow information corresponding to a plurality of flow vectors between a first feature map and a second feature map. For each respective patch of a plurality of patches within the first feature map, a flow query can be performed based on the flow information to determine a corresponding target patch within the second feature map. Feature information for the corresponding target patch can be obtained from the second feature map. Respective feature information for a plurality of neighboring patches included within a virtual expanded range around the corresponding target patch within the second feature map can be obtained from the second feature map, wherein the respective feature information for the plurality of neighboring patches and the feature information for the corresponding target patch are obtained based on the flow query.

### FIELD OF THE DISCLOSURE

The present disclosure generally relates to image processing. For example, aspects of the present disclosure relate to systems and techniques for feature propagation using flow-based warping.

### BACKGROUND

Many devices and systems allow a scene to be captured by generating images (or frames) and/or video data (including multiple frames) of the scene. For example, a camera or a device including a camera can capture a sequence of frames of a scene (e.g., a video of a scene). In some cases, the sequence of frames can be processed for performing one or more functions, can be output for display, can be output for processing and/or consumption by other devices, among other uses.

An artificial neural network attempts to replicate, using computer technology, logical reasoning performed by the biological neural networks that constitute animal brains. Deep neural networks, such as convolutional neural networks, are widely used for numerous applications, such as object detection, object classification, object tracking, big data analysis, among others. For example, convolutional neural networks are able to extract high-level features, such as facial shapes, from an input image, and use these high-level features to output a probability that, for example, an input image includes a particular object.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing image processing based on flow warping. For example, the flow warping described herein can be used to perform feature propagation (e.g., for a two-dimensional (2D) and/or three-dimensional (3D) feature map) and/or other field propagation(s). In some aspects, the systems and techniques can be used for various image processing techniques and/or various field propagation techniques. For instance, the systems and techniques described herein can be used to perform virtual range expansion warping (VREW) to accelerate a feature propagation process and/or a field propagation process. In some cases, virtual range expansion warping can be used to implement one or more machine learning models, such as a denoising diffusion model, a diffusion generative model, a probabilistic latent model, a Markov variational model, etc. In some examples, virtual range expansion warping can be used to perform image processing tasks such as diffusion-based dense prediction and/or propagation-based dense prediction (e.g., motion and/or optical flow estimation, depth estimation, multi-view stereo correspondence and/or disparity estimation, image and/or video inpainting, image reconstruction and/or completion, image editing, neighborhood census field, etc.). In some aspects, the systems and techniques can be used to implement one or more diffusion-based processes in a neural processor (e.g., NPU) and/or various other hardware accelerators, to reduce a processing latency and/or power consumption associated with diffusion inference.

According to at least one illustrative example, a method of image processing based on feature propagation and/or flow warping is provided. The method includes: obtaining flow information corresponding to a plurality of flow vectors between a first feature map and a second feature map of a plurality of feature maps; for each respective patch of a plurality of patches within the first feature map, performing a flow query to determine a corresponding target patch within the second feature map, wherein the flow query is based on the flow information; obtaining, from the second feature map stored in one or more memories, feature information for the corresponding target patch; and obtaining, from the second feature map stored in the one or more memories, respective feature information for a plurality of neighboring patches included within a virtual expanded range around the corresponding target patch within the second feature map, wherein the respective feature information for the plurality of neighboring patches and the feature information for the corresponding target patch are obtained based on the flow query.

In another example, an apparatus is provided. The apparatus includes at least one memory and at least one processor coupled to the at least one memory and configured to: obtain flow information corresponding to a plurality of flow vectors between a first feature map and a second feature map of a plurality of feature maps; for each respective patch of a plurality of patches within the first feature map, perform a flow query to determine a corresponding target patch within the second feature map, wherein the flow query is based on the flow information; obtain, from the second feature map stored in one or more memories, feature information for the corresponding target patch; and obtain, from the second feature map stored in the one or more memories, respective feature information for a plurality of neighboring patches included within a virtual expanded range around the corresponding target patch within the second feature map, wherein the respective feature information for the plurality of neighboring patches and the feature information for the corresponding target patch are obtained based on the flow query.

In another example, a non-transitory computer-readable medium is provided that includes instructions that, when executed by at least one processor, cause the at least one processor to: obtain flow information corresponding to a plurality of flow vectors between a first feature map and a second feature map of a plurality of feature maps; for each respective patch of a plurality of patches within the first feature map, perform a flow query to determine a corresponding target patch within the second feature map, wherein the flow query is based on the flow information; obtain, from the second feature map stored in one or more memories, feature information for the corresponding target patch; and obtain, from the second feature map stored in the one or more memories, respective feature information for a plurality of neighboring patches included within a virtual expanded range around the corresponding target patch within the second feature map, wherein the respective feature information for the plurality of neighboring patches and the feature information for the corresponding target patch are obtained based on the flow query.

In another example, an apparatus is provided. The apparatus includes: means for obtaining flow information corresponding to a plurality of flow vectors between a first feature map and a second feature map of a plurality of feature maps; means for performing, for each respective patch of a plurality of patches within the first feature map, a flow query to determine a corresponding target patch within the second feature map, wherein the flow query is based on the flow information; means for obtaining, from the second feature map stored in one or more memories, feature information for the corresponding target patch; and means for obtaining, from the second feature map stored in the one or more memories, respective feature information for a plurality of neighboring patches included within a virtual expanded range around the corresponding target patch within the second feature map, wherein the respective feature information for the plurality of neighboring patches and the feature information for the corresponding target patch are obtained based on the flow query.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example architecture of an image processing system, in accordance with some examples;

FIG. 2 is a block diagram illustrating an example implementation of a system, which may include a central processing unit (CPU) configured to perform one or more of the functions described herein, in accordance with some examples;

FIG. 3 is a diagram illustrating a first set of images representing a forward diffusion process (e.g., which is fixed) of a diffusion model, and a second set of images representing a reverse diffusion process (e.g., which is learned) of a diffusion model, in accordance with some examples;

FIG. 4 is a diagram illustrating an example of the distribution of diffusion data from initial data to noise using a diffusion model in the forward diffusion direction, in accordance with some examples;

FIG. 5 is a diagram illustrating a U-Net architecture for a diffusion model, in accordance with some examples;

FIG. 6 is a diagram illustrating an example of randomized nearest neighbor feature propagation, in accordance with some examples;

FIG. 7 is a diagram illustrating an example of feature map propagation based on determining flow queries for a stacked plurality of shifted feature map memory objects (e.g., a stacked plurality of shifted feature map copies), in accordance with some examples;

FIG. 8 is a diagram illustrating an example of feature map propagation based on determining flow queries for a stacked plurality of shifted flows applied to a single copy of a feature map, in accordance with some examples;

FIG. 9 is a diagram illustrating an example of feature map propagation using virtual range expansion warping, based on reading a neighborhood parch of features expanded around a flow query applied to a single copy of a feature map, in accordance with some examples;

FIG. 10 is a diagram illustrating an example of virtual range expansion warping where memory and query complexity is not a function of the neighborhood size for the propagation range, in accordance with some examples;

FIG. 11 is a flowchart diagram illustrating an example of a process for feature propagation, in accordance with some examples; and

FIG. 12 is a block diagram illustrating an example of a computing system, which may be employed by the disclosed systems and techniques, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

As noted above, machine learning systems (e.g., deep neural network systems or models) can be used to perform a variety of tasks such as, for example and without limitation, detection and/or recognition (e.g., scene or object detection and/or recognition, face detection and/or recognition, etc.), depth estimation, pose estimation, image reconstruction, classification, three-dimensional (3D) modeling, dense regression tasks, data compression and/or decompression, and image processing, among other tasks. Moreover, machine learning models can be versatile and can achieve high quality results in a variety of tasks.

In some cases, various machine learning models and/or machine learning tasks can be implemented and performed using diffusion. For example, machine learning diffusion models are a class of generative models that can be used to simulate a data generation process based on transforming a simple starting distribution (e.g., such as Gaussian noise) into a more complex data distribution with a desired form and/or contents. Diffusion models can be trained to generate new data that is similar to the data seen during training of the diffusion models. For instance, a diffusion model trained on images of human faces can generate new, realistic images of human faces that were not seen during training. Diffusion models can be trained and/or implemented based on a forward diffusion process and a reverse diffusion process. For example, in the forward diffusion process, noise is added to an input (e.g., a training data input). In the reverse diffusion process, the diffusion model learns to reverse the forward diffusion process, effectively denoising the data to recover the original distribution and/or to create new samples.

In an image processing and/or image generation example, a diffusion model can be configured to add Gaussian noise to an image over several timesteps of the forward diffusion process, progressively transforming the input image into pure noise. In the reverse diffusion process, the diffusion model learns to reconstruct the original input image from this noise, based on a neural network or other machine learning architecture trained to predict the noise and subtract the predicted noise in a reverse stepwise manner. Image processing diffusion models can be used to generate high-quality images and details, based at least in part on the stability of the image processing diffusion models in the reverse diffusion direction. The stability of diffusion models in the reverse direction can correspond to each step of the reverse diffusion process further refining the image to enhance fidelity and coherence. Diffusion models are a class of generative machine learning models, and can be implemented using a flexible architecture that can be adapted to various different data types and/or tasks. For instance, Diffusion models can be used for various tasks such as image generation, natural language processing (e.g., text generation, etc.), audio processing (e.g., generating high-fidelity sound, performing speech synthesis, etc.), etc.

However, diffusion models implement the reverse diffusion process as an iterative process, and inference by a diffusion model can be associated with a relatively high or long latency. For example, a larger number of iterations performed by the diffusion model during a reverse diffusion inference process can correspond to an increased latency. The relatively high latency of diffusion models can limit the use of diffusion models for real-time processing tasks, as many diffusion models may require hundreds or thousands of iterations to achieve high-quality results. A relatively high computational complexity associated with performing inference using a diffusion model can additionally limit the use of diffusion models for on-device and/or mobile processing implementations.

There is a need for systems and techniques that can be used to accelerate diffusion model inference. There is a further need for systems and techniques that can be used to implement diffusion models and/or perform diffusion model inference using computationally constrained computing devices such as smartphones, XR/AR devices, etc.

In some cases, flow-based propagation techniques and/or flow-based propagation machine learning models may be used as an alternative to a machine learning diffusion model. As noted above, diffusion models may operate based on gradually adding noise to an image until the image is transformed into a random noise distribution, and subsequently learning to reverse the noise-addition process, such that the diffusion model effectively captures complex data distributions using a series of denoising steps. Flow-based propagation models can be used to perform the same and/or similar tasks as a diffusion model, where the flow-based propagation models may be associated with a shorter inference time (e.g., lower latency) and a lower output quality than diffusion models.

Flow-based propagation models can be configured to learn the distribution of data using a series of invertible transformations. For instance, flow-based propagation can be performed to transform data between states while preserving at least a portion of an underlying distribution or structure across the states. In an image processing example, flow warping can be implemented based on using a flow-based model to learn and/or determine a flow field that warps one image (e.g., a first state) to align with another image (e.g., a second state). Flow-based propagation and flow warping can be implemented based on a series of smooth, reversible transformations that maintain the structure and properties of the original data. The reversible transformations associated with flow-based propagation can correspond to the determined flow field, which may also be referred to as a flow map and/or an invertible mapping. For instance, an optical flow map is an example of a flow field that can be used to warp one image (e.g., a first frame in a sequence of images or video frames) into another (e.g., a second frame in the sequence of images or video frames), where the optical flow is represented as a field of velocity vectors indicative of the displacement of points from one frame to another.

Existing techniques for flow-based propagation and flow warping can be computationally complex (e.g., computationally expensive) to implement and/or execute, based on the use of sporadic memory read/write (R/W) accesses that are difficult to parallelize. There is a need for systems and techniques that can be used to more efficiently perform flow-based propagation and flow warping. There is a further need for systems and techniques that can be used to reduce the quantity and/or frequency of memory R/W accesses associated with performing flow-based propagation and flow warping.

In some cases, the term “field propagation” can be used to refer to a process of evolving or transmitting a field (e.g., scalar, vector, probability, etc.) over spatial and/or temporal dimensions. Diffusion models and flow-based models can both be considered classes or types of field propagation models. For instance, diffusion models may perform field propagation where the field being propagated is a probability distribution or noise distribution over an image or data space (e.g., in the forward diffusion direction, the field of image data is propagated towards a field of noise; in the reverse diffusion direction, a field of noise is propagated back to a structured data field).

Flow-based models and flow warping techniques can correspond to the propagation of spatial information. For example, the field being propagated can be associated with the spatial configuration or position of each pixel in an image (e.g., a flow field can be generated as a vector field indicating how each pixel in an image should move to align with a second image). The flow field can propagate the spatial information of an image to another configuration, transforming the original field of pixel positions to a field of new or different pixel positions (e.g., a propagation of the spatial positions and structures within the image).

Systems, apparatuses, processes (also referred to as methods), and computer-readable media (collectively referred to as “systems and techniques”) are described herein that can be used to perform accelerated field propagation with a reduced inference latency and a reduced memory usage. For example, the reduced memory usage can correspond to a reduction in the total memory space used for field propagation and/or flow-based propagation, and/or can correspond to a reduction in the total number of memory queries associated with the field propagation and/or flow-based propagation. In some aspects, the systems and techniques described herein for accelerated field propagation and/or flow-based propagation can be used to implement one or more machine learning diffusion models and/or one or more diffusion-based processing operations. In some cases, the systems and techniques can be used to implement various flow-based propagation and/or flow warping processing operations, including feature map warping by various machine learning models and/or architectures.

In some cases, the systems and techniques can be used to implement field propagation and/or feature map warping for one or more machine learning models, such as a denoising diffusion model, a diffusion generative model, a probabilistic latent model, a Markov variational model, etc. In some examples, the systems and techniques can be used to implement field propagation and/or feature map warping associated with performing image processing tasks such as diffusion-based dense prediction and/or propagation-based dense prediction (e.g., motion and/or optical flow estimation, depth estimation, multi-view stereo correspondence and/or disparity estimation, image and/or video inpainting, image reconstruction and/or completion, image editing, neighborhood census field, etc.). In some aspects, the systems and techniques can be used to implement field propagation and/or feature map warping in a neural processor (e.g., NPU) and/or various other hardware accelerators, to reduce a processing latency and/or power consumption associated with field propagation-based inference (e.g., diffusion model inference, flow-based propagation or flow warping-based inference, etc.).

In one illustrative example, the systems and techniques can be used to implement virtual range expansion warping using flow-based propagation. Memory space usage and/or the number of memory queries can be reduced based on performing the virtual range expansion warping without using multiple copies of shifted feature maps and without using multiple copies of shifted flows. For example, in one illustrative example, the systems and techniques can perform field propagation and virtual range expansion warping between a first feature map (e.g., source) and a second feature map (e.g., target), using only one copy or instance (e.g., the original) of the target feature map and one flow query per patch of the source feature map. A patch can correspond to a single pixel or pixel location and/or may correspond to multiple pixels or pixel locations within a feature map.

Each flow query can be based on a warping and/or flow-based propagation between a particular patch of the source feature map (e.g., source patch) and a particular patch of the target feature map (e.g., target patch). The target patch can be configured as a relative point (e.g., a center point) of neighborhood of patches within the target feature map. For example, the neighborhood of patches can comprise a configurable plurality (e.g., a configured quantity) of patches that are each adjacent to a relative point of the target patch (e.g., the target patch center point) and/or adjacent to one or more patches that are also included in the neighborhood.

In some aspects, each flow query (e.g., from the source feature map to the target feature map) can be configured to read the relative point (e.g., the center point) corresponding to the target patch and to read the patch of features expanded around the target within a virtual radius for correlation. In one illustrative example, the target patch (e.g., neighborhood center point) and the patch of features expanded around the target (e.g., configured neighborhood patches) can be read out using the same (e.g., single) flow query and warping operation between the source and target feature maps. In some aspects, the flow query can be configured to read out the target patch and the patch of features expanded around the target simultaneously (e.g., in parallel). In some examples, a plurality of flow queries can be performed in parallel between the source and target feature maps, where each flow query of the plurality of flow queries corresponds to a respective source patch, a respective target patch, and a respective patch of features expanded around the respective target patch.

Further aspects of the systems and techniques will be described with reference to the figures.

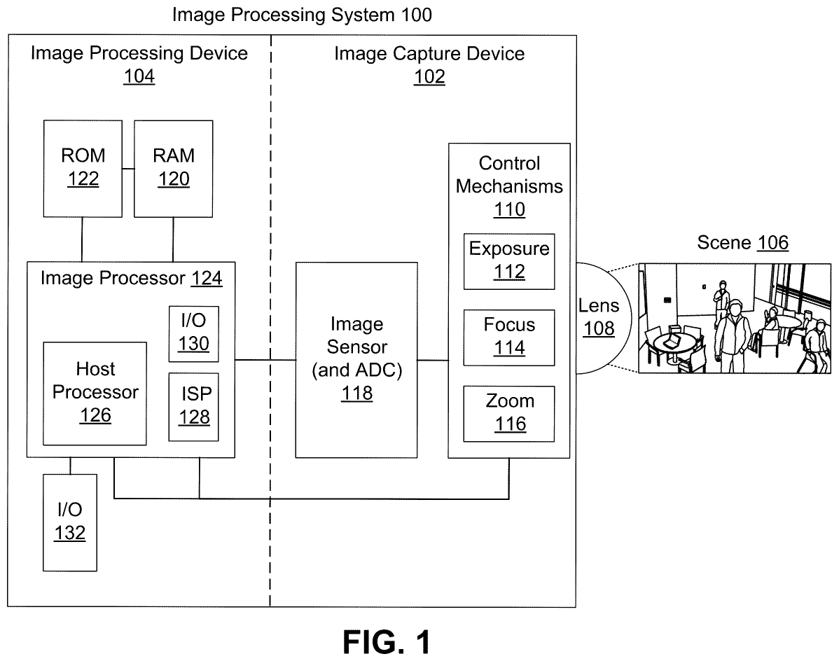

FIG. 1 is a block diagram illustrating an example architecture of an image-processing system 100, according to various aspects of the present disclosure. The image-processing system 100 includes various components that are used to capture and process images, such as an image of a scene 106. The image-processing system 100 can capture image frames (e.g., still images or video frames). In some cases, the lens 108 and image sensor 118 (which may include an analog-to-digital converter (ADC)) can be associated with an optical axis. In one illustrative example, the photosensitive area of the image sensor 118 (e.g., the photodiodes) and the lens 108 can both be centered on the optical axis.

In some examples, the lens 108 of the image-processing system 100 faces a scene 106 and receives light from the scene 106. The lens 108 bends incoming light from the scene toward the image sensor 118. The light received by the lens 108 then passes through an aperture of the image-processing system 100. In some cases, the aperture (e.g., the aperture size) is controlled by one or more control mechanisms 110. In other cases, the aperture can have a fixed size.

The one or more control mechanisms 110 can control exposure, focus, and/or zoom based on information from the image sensor 118 and/or information from the image processor 124. In some cases, the one or more control mechanisms 110 can include multiple mechanisms and components. For example, the control mechanisms 110 can include one or more exposure-control mechanisms 112, one or more focus-control mechanisms 114, and/or one or more zoom-control mechanisms 116. The one or more control mechanisms 110 may also include additional control mechanisms besides those illustrated in FIG. 1. For example, in some cases, the one or more control mechanisms 110 can include control mechanisms for controlling analog gain, flash, HDR, depth of field, and/or other image capture properties.

The focus-control mechanism 114 of the control mechanisms 110 can obtain a focus setting. In some examples, focus-control mechanism 114 stores the focus setting in a memory register. Based on the focus setting, the focus-control mechanism 114 can adjust the position of the lens 108 relative to the position of the image sensor 118. For example, based on the focus setting, the focus-control mechanism 114 can move the lens 108 closer to the image sensor 118 or farther from the image sensor 118 by actuating a motor or servo (or other lens mechanism), thereby adjusting the focus. In some cases, additional lenses may be included in the image-processing system 100. For example, the image-processing system 100 can include one or more microlenses over each photodiode of the image sensor 118. The microlenses can each bend the light received from the lens 108 toward the corresponding photodiode before the light reaches the photodiode.

In some examples, the focus setting may be determined via contrast detection autofocus (CDAF), phase detection autofocus (PDAF), hybrid autofocus (HAF), or some combination thereof. The focus setting may be determined using the control mechanism 110, the image sensor 118, and/or the image processor 124. The focus setting may be referred to as an image capture setting and/or an image processing setting. In some cases, the lens 108 can be fixed relative to the image sensor and the focus-control mechanism 114.

The exposure-control mechanism 112 of the control mechanisms 110 can obtain an exposure setting. In some cases, the exposure-control mechanism 112 stores the exposure setting in a memory register. Based on the exposure setting, the exposure-control mechanism 112 can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 118 (e.g., ISO speed or film speed), analog gain applied by the image sensor 118, or any combination thereof. The exposure setting may be referred to as an image capture setting and/or an image processing setting.

The zoom-control mechanism 116 of the control mechanisms 110 can obtain a zoom setting. In some examples, the zoom-control mechanism 116 stores the zoom setting in a memory register. Based on the zoom setting, the zoom-control mechanism 116 can control a focal length of an assembly of lens elements (lens assembly) that includes the lens 108 and one or more additional lenses. For example, the zoom-control mechanism 116 can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 108 in some cases) that receives the light from the scene 106 first, with the light then passing through a focal zoom system between the focusing lens (e.g., lens 108) and the image sensor 118 before the light reaches the image sensor 118. The focal zoom system may, in some cases, include two positive (e.g., converging, convex) lenses of equal or similar focal length (e.g., within a threshold difference of one another) with a negative (e.g., diverging, concave) lens between them. In some cases, the zoom-control mechanism 116 moves one or more of the lenses in the focal zoom system, such as the negative lens and one or both of the positive lenses. In some cases, zoom-control mechanism 116 can control the zoom by capturing an image from an image sensor of a plurality of image sensors (e.g., including image sensor 118) with a zoom corresponding to the zoom setting. For example, the image-processing system 100 can include a wide-angle image sensor with a relatively low zoom and a telephoto image sensor with a greater zoom. In some cases, based on the selected zoom setting, the zoom-control mechanism 116 can capture images from a corresponding sensor.

The image sensor 118 includes one or more arrays of photodiodes or other photosensitive elements. Each photodiode measures an amount of light that eventually corresponds to a particular pixel in the image produced by the image sensor 118. In some cases, different photodiodes may be covered by different filters. In some cases, different photodiodes can be covered in color filters, and may thus measure light matching the color of the filter covering the photodiode. Various color filter arrays can be used such as, for example and without limitation, a Bayer color filter array, a quad color filter array (QCFA), and/or any other color filter array.

In some cases, the image sensor 118 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 118 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 110 may be included instead or additionally in the image sensor 118. The image sensor 118 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

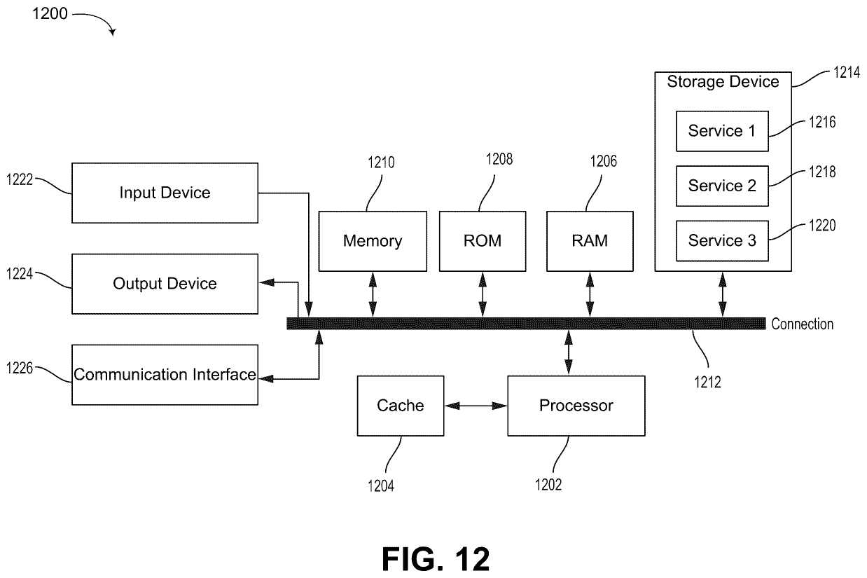

The image processor 124 may include one or more processors, such as one or more image signal processors (ISPs) (including ISP 128), one or more host processors (including host processor 126), and/or one or more of any other type of processor discussed with respect to the computing-device architecture 1200 of FIG. 12. The host processor 126 can be a digital signal processor (DSP) and/or other type of processor. In some implementations, the image processor 124 is a single integrated circuit or chip (e.g., referred to as a system-on-chip or SoC) that includes the host processor 126 and the ISP 128. In some cases, the chip can also include one or more input/output ports (e.g., input/output (I/O) ports 130), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 130 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General-Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 126 can communicate with the image sensor 118 using an I2C port, and the ISP 128 can communicate with the image sensor 118 using an MIPI port.

The image processor 124 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 124 may store image frames and/or processed images in random-access memory (RAM) 120, read-only memory (ROM) 122, a cache, a memory unit, another storage device, or some combination thereof.

Various input/output (I/O) devices 132 may be connected to the image processor 124. The I/O devices 132 can include a display screen, a keyboard, a keypad, a touchscreen, a trackpad, a touch-sensitive surface, a printer, any other output devices, any other input devices, or any combination thereof. In some cases, a caption may be input into the image-processing device 104 through a physical keyboard or keypad of the I/O devices 132, or through a virtual keyboard or keypad of a touchscreen of the I/O devices 132. The I/O devices 132 may include one or more ports, jacks, or other connectors that enable a wired connection between the image-processing system 100 and one or more peripheral devices, over which the image-processing system 100 may receive data from the one or more peripheral device and/or transmit data to the one or more peripheral devices. The I/O devices 132 may include one or more wireless transceivers that enable a wireless connection between the image-processing system 100 and one or more peripheral devices, over which the image-processing system 100 may receive data from the one or more peripheral device and/or transmit data to the one or more peripheral devices. The peripheral devices may include any of the previously-discussed types of the I/O devices 132 and may themselves be considered I/O devices 132 once they are coupled to the ports, jacks, wireless transceivers, or other wired and/or wireless connectors.

In some cases, the image-processing system 100 may be a single device. In some cases, the image-processing system 100 may be two or more separate devices, including an image-capture device 102 (e.g., a camera) and an image-processing device 104 (e.g., a computing device coupled to the camera). In some implementations, the image-capture device 102 and the image-capture device 102 may be coupled together, for example via one or more wires, cables, or other electrical connectors, and/or wirelessly via one or more wireless transceivers. In some implementations, the image-capture device 102 and the image-processing device 104 may be disconnected from one another.

As shown in FIG. 1, a vertical dashed line divides the image processing system 100 of FIG. 1 into two portions that represent the image capture device 102 and the image processing device 104, respectively. The image capture device 102 includes the lens 108, the control mechanisms 110, and the image sensor 118. The image processing device 104 includes the image processor 124 (including the ISP 128 and the host processor 126), the RAM 120, the ROM 122, and the I/O device 132. In some cases, certain components illustrated in the image capture device 102 (e.g., such as the ISP 128 and/or the host processor 126), may be included in the image capture device 102. In some examples, the image processing system 100 can include one or more wireless transceivers for wireless communications, such as cellular network communications, 802.11 Wi-Fi communications, wireless local area network (WLAN) communications, or some combination thereof.

The image-processing system 100 can be part of, or implemented by, a single computing device or multiple computing devices. In some examples, the image-processing system 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a laptop or notebook computer, a tablet computer, a set-top box, a smart television, a display device, a game console, an XR device (e.g., an HMD, smart glasses, etc.), an IoT (Internet-of-Things) device, a smart wearable device, a video streaming device, an Internet Protocol (IP) camera, or any other suitable electronic device(s).

While the image-processing system 100 is shown to include certain components, one of ordinary skill will appreciate that the image processing system 100 can include more components than those shown in FIG. 1. The components of the image-processing system 100 can include software, hardware, or one or more combinations of software and hardware. For example, in some implementations, the components of the image processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image-processing system 100.

In some examples, the computing-device architecture 1200 shown in FIG. 12 and further described below can include the image-processing system 100, the image-capture device 102, the image-processing device 104, or a combination thereof.

As noted above, various aspects of the present disclosure can use machine-learning models or systems.

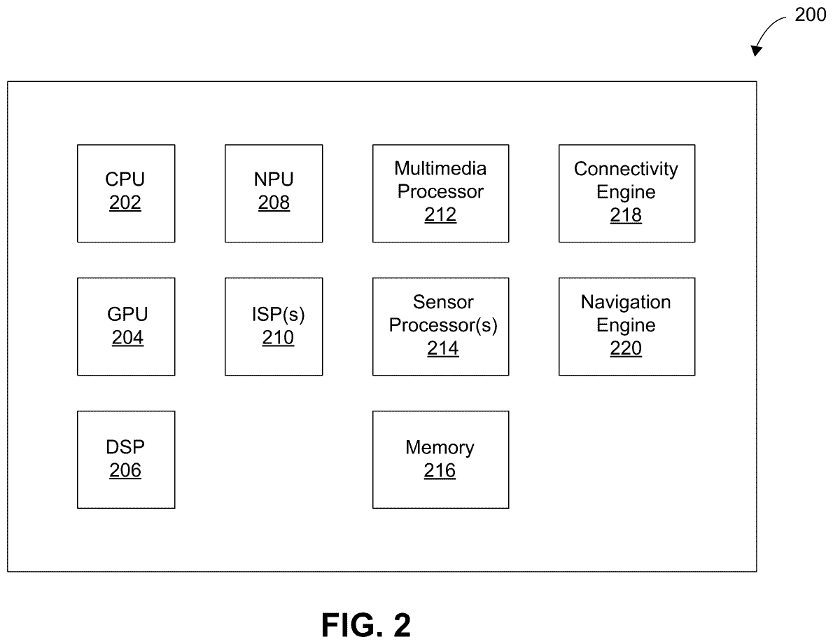

FIG. 2 illustrates an example implementation of a system 200, which may include a central processing unit (CPU 202) (which may be a multi-core CPU), configured to perform one or more of the functions described herein. Parameters or variables (e.g., neural signals and synaptic weights), system parameters associated with a computational device (e.g., neural network with weights), task information, among other information may be stored in a memory block associated with a neural processing unit (NPU 208), in a memory block associated with a CPU 202, in a memory block associated with a graphics processing unit (GPU 204), in a memory block associated with a digital signal processor (DSP 206), in a memory 216, and/or may be distributed across multiple blocks. Instructions executed at the CPU 202 may be loaded from a program memory associated with the CPU 202 or may be loaded from memory 216.

The system 200 may also include additional processing blocks tailored to specific functions, such as the GPU 204, the DSP 206, a connectivity engine 218, which may include fifth generation (5G) connectivity, fourth generation long term evolution (4G LTE) connectivity, Wi-Fi connectivity, USB connectivity, Bluetooth connectivity, and the like, and a multimedia processor 212 that may, for example, detect and recognize gestures. In one implementation, the NPU is implemented in the CPU 202, the DSP 206, and/or the GPU 204. The system 200 may also include one or more sensor processor(s) 214, one or more image signal processors (ISP(s) 210), and/or navigation engine 220, which may include a global positioning system. In some examples, the sensor processor(s) 214 can be associated with or connected to one or more sensors for providing sensor input(s) to the sensor processor(s) 214. For example, the one or more sensors and sensor processor(s) 214 can be provided in, coupled to, or otherwise associated with a same computing device.

The system 200 may be implemented as a system on a chip (SoC). The system 200 may be based on an Advanced Reduced Instruction Set Computer (RISC) Machine (ARM) instruction set. The system 200 and/or components thereof may be configured to perform machine learning techniques according to aspects of the present disclosure discussed herein. For example, the system 200 and/or components thereof may be configured to implement a machine-learning model (e.g., a quantized trained machine-learning model) as described herein and/or according to aspects of the present disclosure.

Machine learning (ML) can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, diffusion-based neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

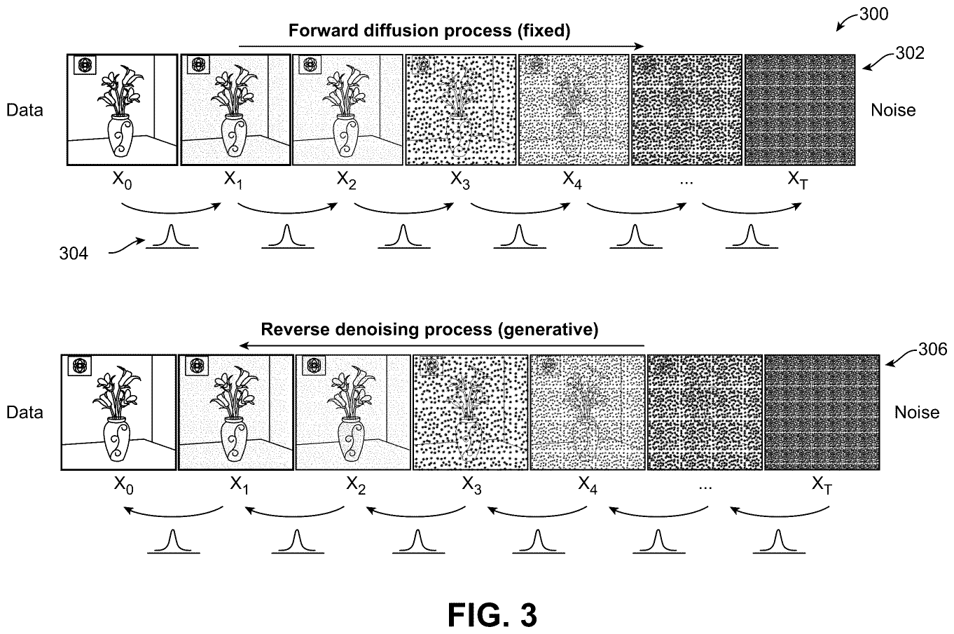

As noted previously, machine learning diffusion models can be implemented and/or configured as a class of generative machine learning models that can be used to simulate a data generation process based on transforming a simple starting distribution (e.g., such as Gaussian noise) into a more complex data distribution with a desired form and/or contents. FIG. 3 is a diagram illustrating an example of a forward diffusion process and a reverse diffusion process that can be implemented by a machine learning diffusion model.

For example, FIG. 3 provides two sets of images 300 that show the forward diffusion process (e.g., which is fixed) and the reverse diffusion process (e.g., which is learned) of a diffusion model. The reverse diffusion process can also be referred to as a “reverse denoising process.” As noted previously, the reverse diffusion process can be a generative process, and may be used to perform inference using a trained machine learning diffusion model.

As shown in the forward diffusion process of FIG. 3, noise 304 is gradually added to a first set of images 302 at different time steps for a total of T time steps (e.g., making up a Markov chain), producing a sequence of noisy samples X₁ through X_{T}.

Diffusion models from a training perspective will take an image and will slowly add noise to the image to destroy the information in the image. In some aspects, the noise 304 is Gaussian noise. Each time step can correspond to each consecutive image of the first set of images 302 shown in FIG. 3. The initial image X₀ of FIG. 3 is of a vase of flowers. Addition of the noise 304 to each image (corresponding to noisy samples X₁ to X_{T}) results in gradual diffusion of the pixels in each image until the final image (corresponding to sample X_{T}) essentially matches the noise distribution. For example, by adding the noise, each data sample X₁ through X_{T} gradually loses its distinguishable features as the time step becomes larger, eventually resulting in the final sample X_{T} being equivalent to the target noise distribution, for instance a unit variance zero-Gaussian N(0,1).

The second set of images 306 shows the reverse diffusion process in which X_{T} is the starting point with a noisy image (e.g., one that has Gaussian noise). The diffusion model can be trained to reverse the diffusion process (e.g., by training a model p_{θ}(xₜ₋₁|xₜ)) to generate new data. In some aspects, a diffusion model can be trained by finding the reverse Markov transitions that maximize the likelihood of the training data. By traversing backwards along the chain of time steps, the diffusion model can generate the new data. For example, as shown in FIG. 3, the reverse diffusion process proceeds to generate X₀ as the image of the vase of flowers. In other cases, the input data and output data can vary based on the task for which the diffusion model is trained.

As noted above, the diffusion model is trained to be able to denoise or recover the original image X₀ in an incremental process as shown in the second set of images 306. In some aspects, the neural network of the diffusion model can be trained to recover Xₜ given Xₜ₋₁, such as provided in the below example equation:

$$q ( {x}_{t} \vert {x}_{t - 1} ) = 𝒩 ( {x}_{t} ; \sqrt{1 - {β}_{t}} {x}_{t - 1} , {β}_{t} I )$$

A diffusion kernel can be defined as:

$$Define {\hat{∝}}_{t} = {\prod }_{s = 1}^{t} ( 1 - {β}_{s} ) \to q ( {x}_{t} \vert {x}_{0} ) = 𝒩 ( {x}_{t} ; \sqrt{{\hat{∝}}_{t}} {x}_{0} , ( 1 - {\hat{∝}}_{t} ) I )$$

Sampling can be defined as follows:

$${x}_{t} = \sqrt{{\hat{∝}}_{t}} {x}_{0} + \sqrt{1 - {\hat{∝}}_{t}} ε where ε \sim 𝒩 ( O , I ) .$$

In some cases, the βₜ values schedule (also referred to as a noise schedule) is designed such that \hat{∝}_{T}→0 and q(x_{T}|x₀)≈ [symbol] (x_{T}; 0, I).

The diffusion model runs in an iterative manner to incrementally generate the input image X₀. In one example, the model may have twenty steps. However, in other examples, the number of steps can vary.

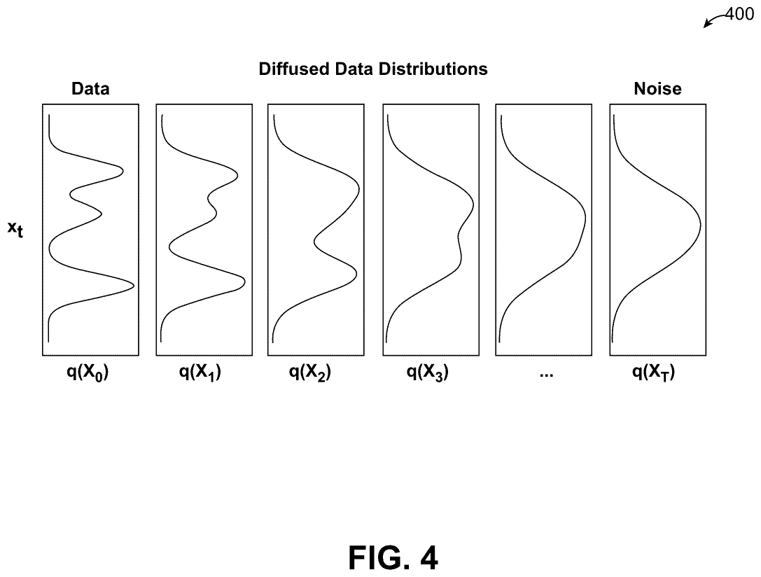

FIG. 4 is a diagram 400 illustrating how diffusion data is distributed from initial data to noise using a diffusion model in the forward diffusion direction, in accordance with some aspects. Note that the initial data q (X₀) is detailed in the initial stage of the diffusion process. An illustrative example of the data q (X₀) is the initial image of the vase of flowers shown in FIG. 3. As the diffusion model iterates and iteratively adds sampled noise to the data from t=0 to t=T, as shown in FIG. 4, the data becomes nosier and may ultimately result in pure noise (e.g., at q (X_{T})). The example of FIG. 4 illustrates the progression of the data and how it becomes diffused with noise in the forward diffusion process.

In some aspects, the diffused data distribution (e.g., as shown in FIG. 4) can be as follows:

$$q ( {x}_{t} ) = \int q ( {x}_{0} , {x}_{t} ) {dx}_{0} = \int d ( {x}_{0} ) q ( {x}_{t} \vert {x}_{0} ) {dx}_{0} .$$

In the above equation, q(xₜ) represents the diffused data distribution, q(x₀, xₜ) represents the joint distribution, q(x₀) represents the input data distribution, and q(xₜ|x₀) is the diffusion kernel. In this regard, the model can sample xₜ˜q(xₜ) by first sampling x₀˜q(x₀) and then sampling xₜ˜q(xₜ|x₀) (which may be referred to as ancestral sampling). The diffusion kernel takes the input and returns a vector or other data structure as output.

The following is a summary of a training algorithm and a sampling algorithm for a diffusion model. A training algorithm can include the following steps:

1: repeat
2: x₀ ~ q(x₀)
3: t ~ Uniform ({1,...,T })
4: ∈ ~ [symbol] (0, I)
5: Take gradient descent step on
∇_{Ø} ∥ ∈ − ∈_{Ø} (\sqrt{\hat{α}ₜ x₀}+ \sqrt{1 − \hat{α}ₜ}∈, t) ∥²
6: until converged

A sampling algorithm can include the following steps:

| | |
|---|---|
| 1: | x_{T} ~ [symbol] (0, I) |
| 2: | for t = T, . . . , 1 do |
| 3: | z ~ [symbol] (0, I) |
| 4: | ${x}_{t - 1} = \frac{1}{\sqrt{{\hat{∝}}_{t}}} ( {x}_{t} - \frac{1 - {\hat{∝}}_{t}}{\sqrt{1 - {\hat{∝}}_{t}}} {∈}_{∅} ( {x}_{t} , t ) ) + {σ}_{t} z$ |
| 5: | end for |
| 6: | return x₀ |

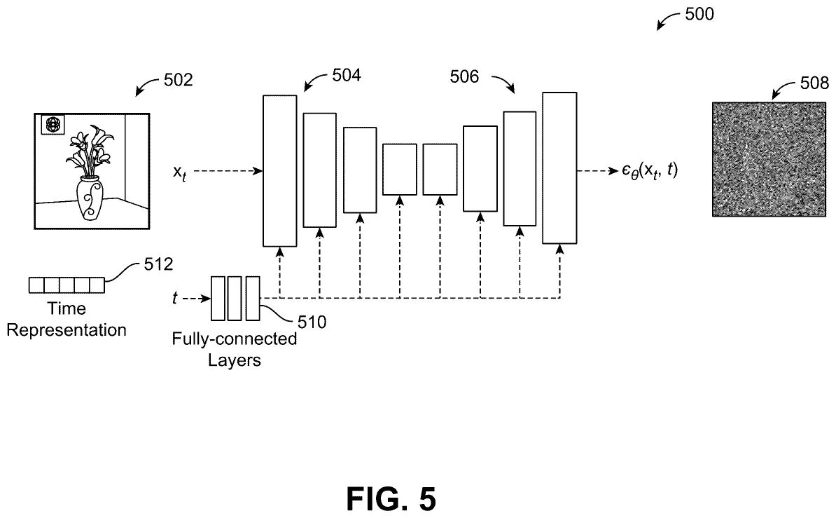

FIG. 5 is a diagram illustrating an example U-Net machine learning architecture 500 that can be used to implement a diffusion model, in accordance with some examples. The initial image 502 (e.g., of a vase of flowers) is provided to the U-Net architecture 500 which includes a series of residual networks (ResNet) blocks and self-attention layers to represent the network ϵ_{θ}(xₜ, t). The U-Net architecture 500 also includes fully connected layers 510. In some cases, time representation 512 can be sinusoidal positional embeddings or random Fourier features. Noisy output 508 from the forward diffusion process is also shown.

The U-Net architecture 500 includes a contracting path 504 and an expansive path 506 as shown in FIG. 5, which gives it the U-shaped architecture. The contracting path 504 can be a convolutional network that includes repeated convolutional layers (that apply convolutional operations), each followed by a rectified linear unit (ReLU) and a max pooling operation. When images are being processed (e.g., the image 502) during the contracting path 504, the spatial information of the image 502 is reduced as features are generated. The expansive path 506 combines the features and spatial information through a sequence of up-convolutions and concatenations with high-resolution features from the contracting path 504. Some of the layers can be self-attention layers, which leverage global interactions between semantic features at the end of the encoder to explicitly model full contextual information.

As noted previously, systems and techniques are described herein that can be used to perform accelerated field propagation with a reduced inference latency and a reduced memory usage. For example, the reduced memory usage can correspond to a reduction in the total memory space used for field propagation and/or flow-based propagation, and/or can correspond to a reduction in the total number of memory queries associated with the field propagation and/or flow-based propagation. In some aspects, the systems and techniques described herein for accelerated field propagation and/or flow-based propagation can be used to implement one or more machine learning diffusion models and/or one or more diffusion-based processing operations. In some cases, the systems and techniques can be used to implement various flow-based propagation and/or flow warping processing operations, including feature map warping by various machine learning models and/or architectures.

In some cases, field propagation and/or flow-based propagation associated with various image processing techniques and/or operations can be performed based on nearest-neighbor matches between image patches. An image patch can include a single pixel, or can include a group of multiple pixels (e.g., adjacent pixels included within a patch area, such as a square patch of j×j pixels, etc.). In some examples, flow-based propagation can be performed based on determining approximate nearest-neighbor matches between image patches.

For example, the approximate nearest-neighbor matches can be determined utilizing randomized nearest neighbor feature propagation. In randomized nearest neighbor feature propagation, one or more good patch matches can be found or determined using random sampling. Based on natural coherence in the underlying imagery, such matches can be propagated quickly to surrounding areas, to determine approximate nearest-neighbor matches for an entire input image or map that includes a plurality of patches.

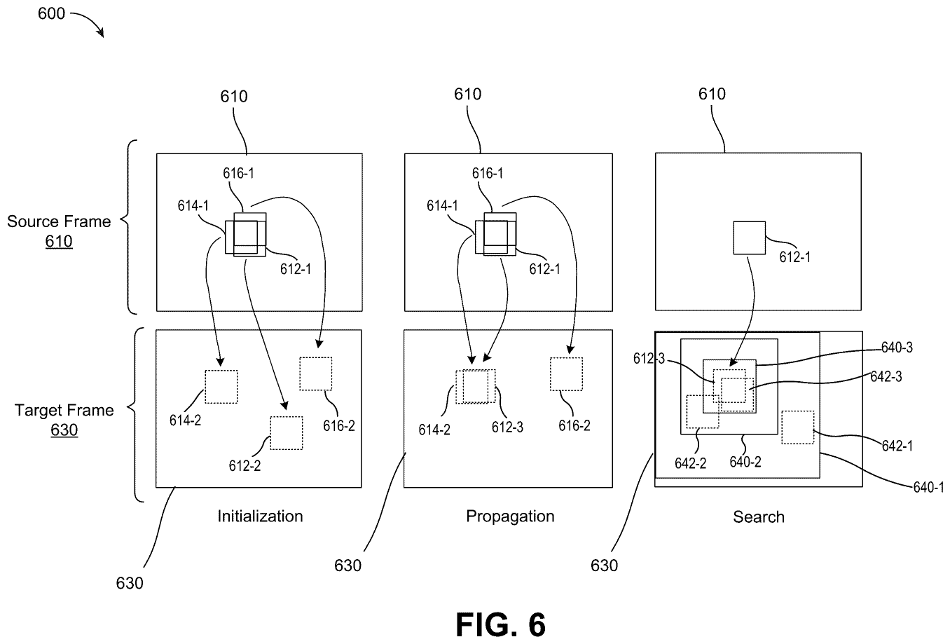

FIG. 6 is a diagram illustrating an example of randomized nearest neighbor feature propagation 600, in accordance with some examples. The randomized nearest neighbor feature propagation 600 can be implemented using iterative steps of (a) random initialization, (b) propagation, and (c) search, followed by subsequent iterations of the repeated process to iteratively propagate the currently identified best patch matches to one or more neighboring patches.

For example, patch matching can be performed to determine approximate nearest neighbor matches for a plurality of patches between a source frame 610 and a target frame 630. The source and target frames 610 and 630 (respectively) can be image frames, feature maps, etc., for example associated with a sequence of images or video frames. The source frame 610 can include a plurality of overlapping patches 612-1, 614-1, 616-1, etc.

A random initialization can be performed to generate a randomly initialized nearest neighbor field (NNF) between the patches of the source frame 610 and the patches of the target frame 630. For instance, the randomly initialized NNF can include a randomly initialized flow between the source frame patch 612-1 and the target frame patch 612-2, a randomly initialized flow between the source frame patch 614-1 and the target frame patch 614-2, a randomly initialized flow between the source frame patch 616-1 and the target frame patch 616-2, etc. The randomly initialized NNF can include a randomly initialized flow between each respective patch of a plurality of patches in the source frame 610 and a random patch of a plurality of patches in the target frame 630. After random initialization, the NNF maps each patch in the source frame 610 to a random corresponding patch in the target frame 630.

The randomized nearest neighbor feature propagation 600 can subsequently be performed to iteratively improve the randomly initialized NNF (e.g., from the initialization step (a) of FIG. 6). Each iteration can include a propagation step (e.g., the propagation step (b) of FIG. 6) and a random search step (e.g., the search step (c) of FIG. 6).

For example, after random initialization of the NNF (e.g., flows between each source frame 610 patch to a corresponding random target frame 630 patch), each iteration can go through all patches in the source frame 610 and perform propagation and random search at each source frame 610 patch.

For instance, the propagation step can be implemented based on the coherence in natural images, and an assumption that if a patch has a good match, then its neighbors will likely have similar matches. During propagation, the current match (e.g., in the target frame 630) for a respective patch of the source frame 610 is checked against the matches of the neighbors of the respective patch. For example, the neighboring patches for the source frame patch 612-1 can include the patch 614-1 (e.g., a left shift or perturbation from the patch 612-1) and the patch 616-1 (e.g., an upward shift or perturbation from the patch 612-1), etc. Neighboring patches for source frame patch 612-1 can additionally include a right perturbation and a downward perturbation from patch 612-1, although not shown in the example of FIG. 6.

For example, during the propagation step, the left and top neighbors of the patch 612-1 can be checked to determine if the current match (e.g., within target frame 630) for one of the neighboring patches (e.g., within source frame 610) is better than the current match 619-2 for the patch 612-1.

For instance, during the propagation step for source patch 612-1, the source patch 612-1 can be associated with a current match given by a flow to the target patch 612-2. The matches of the neighboring source patches 614-1 and 616-1 (e.g., left and top neighbor for patch 612-1) can be tested and compared to the current match 612-2 for patch 612-1. In some aspects, the propagation and testing of neighboring patch matches can be performed based on shifting current matches by small 2D perturbations Δp={all combinations of directional perturbation}={(−p,−p), (−p, p), (p,−p), (p, p)}.

For example, the current match 614-2 for neighbor 614-1 can be perturbed and tested against the current match 612-2 for patch 612-1, and the current match 616-2 for neighbor 616-1 can be perturbed and tested against the current match 612-2 for patch 612-1. In some cases, the current matches 614-2 and 616-2 for the neighbors 614-1 and 616-2 (respectively) can each be perturbed by the small 2D perturbations Δp, followed by warping before similarity evaluation (e.g., correlation) is determined between the original feature and shifted features:

$$Corr = {F}_{1} \cdot {F}_{2}^{′}$$

F₂′=W(S(F₂,Δp),f)

Δp={all combinations of directional perturbation}

F₁ represents the source feature map 610. F₂ represents the target feature map 630, and F₂ represents the set of shifted feature maps generated based on applying a respective one of the set of perturbations Δp to the target feature map F₂. f represents the flow (e.g., spatial disparity) between a source feature in F₁ and a target feature in F₂. S( ) represents a spatial shift function that can be used to apply the perturbation(s) Δp, and W( ) represents a warp function that can be used to warp the spatially shifted feature maps based on the configured flow or spatial disparity f.

If a better match is found, the current match for the source frame patch is updated to the better match of the neighbor. For instance, during the propagation step for the source frame patch 612-1, the similarity evaluation (e.g., correlation) given in the equations above can be determined between the original features of patch 612-1 and a set of candidate matches that comprises one or more (or all) of: the current match 612-2, the current neighboring match 614-2, the Δp perturbations of the current neighboring match 614-2, the current neighboring match 616-2, and/or the Δp perturbations of the current neighboring match 616-2.

For instance, the similarity evaluation (e.g., correlation) determined during the propagation step for source patch 612-1 may determine that the rightward perturbation of neighboring match 614-2 is a better match for the features of source patch 612-1 than the current match 612-2. Based on identifying the better similarity of the match with source patch 612-1, the current match for source patch 612-1 can be updated to target patch 612-3 (e.g., the rightward perturbation of neighboring match 614-2).

After the propagation step described above, each iteration can perform a random search around the current match for each source frame 610 patch. For instance, after updating the current match for source patch 612-1 to the target patch 612-3, a random search can be performed around the current match 612-3. The random search can be used to escape local minima and further improve the patch matches (e.g., increase the similarity and/or correlation of the matching patch for the source patch 612-1).

For instance, the random search can be performed based on sampling additional patches within the target frame 630 and using exponentially decreasing windows around the current best match 612-3 identified for the source patch 612-1 during the propagation step. Each sample can be drawn from a uniform distribution in a square neighborhood centered at the current best match 612-3, with each sample taken from a smaller window until the sampling window becomes smaller than a configured size.

For example, a first random sample 642-1 can be obtained from a first window 640-1 within the target frame 630 and centered at the current best match 612-3. A second random sample 642-2 can be obtained from a second, smaller window 640-2 that is within the target frame 630 (and within the first window 640-1). A third random sample 642-3 can be obtained from a third, still smaller window 640-3 that is within the target frame 630 (and within the second window 640-2), etc.

Each of the random samples 642-1, 642-2, 642-3, . . . , etc., drawn from the exponentially decreasing windows 640-1, 640-2, 640-3, . . . , etc., are checked to determine if the random sample provides a better match to the source patch 612-1 than the current best match 612-3. If one of the random samples provides a better match, the current best match for the source patch 612-1 is updated to the better matching one of the random samples 642-1, 642-2, 642-3, . . . , etc. The random search step can be used to prevent the randomized nearest neighbor feature propagation 600 from becoming stuck in a local optimum.

In each iteration, the propagation step (b) and random search step (c) can be performed for each patch of the plurality of patches included in the source frame 610. The propagation step (b) and random search step (c) can be repeated for multiple iterations to improve the quality of the nearest neighbor field (NNF) corresponding to the flows between each respective patch of the source frame 610 to a corresponding best match patch within the target frame 630.

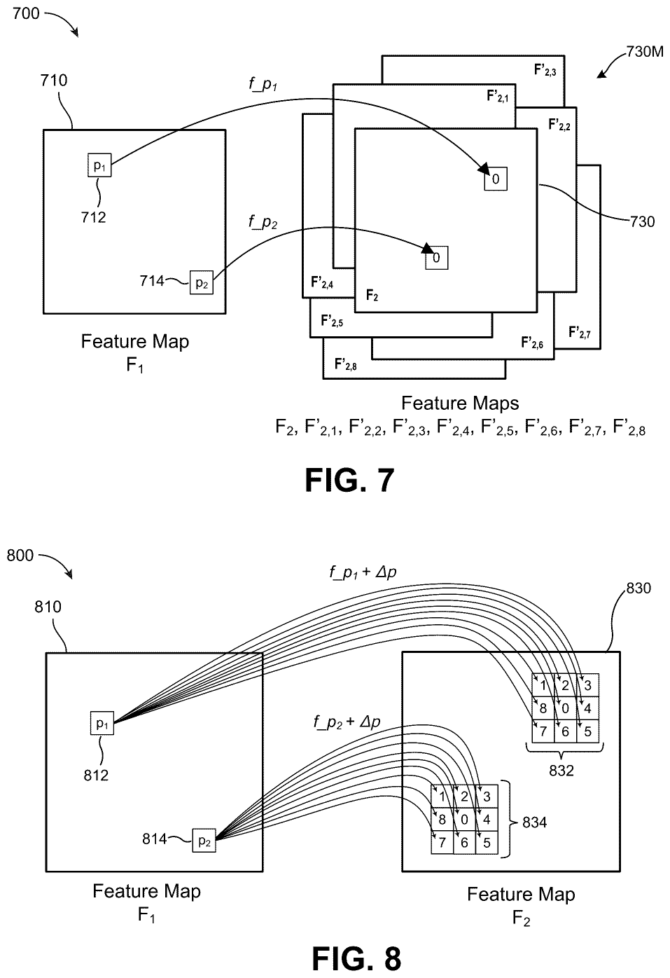

FIG. 7 is a diagram illustrating an example of a feature map propagation 700 based on randomized nearest neighbor. For instance, the feature map propagation 700 can correspond to the randomized nearest neighbor feature propagation 600 of FIG. 6. In one illustrative example, a first feature map F₁ 710 of FIG. 7 can be a source feature map, and may be the same as or similar to the source frame 610 of FIG. 6.

A plurality of stacked feature maps 730M can include a target feature map F₂ (e.g., target feature map 730) and a set of shifted feature maps F′_{2,1}, F′_{2,2}, F′_{2,3}, F′_{2,4}, F′_{2,5}, F′_{2,6}, F′_{2,7}, and F′_{2,8}. The target feature map F₂ 730 can be a non-shifted target feature map, and may be the same as or similar to the target frame 630 of FIG. 6. The set of shifted feature maps (e.g., F′_{2,1}, F′_{2,2}, F′_{2,3}, F′_{2,4}, F′_{2,5}, F′_{2,6}, F′_{2,7}, and F′_{2,8}) can be shifted copies of the target feature map F₂ 730, where each respective shifted feature map of the set of shifted feature maps is shifted or offset from the target feature map F₂ 730 by a corresponding one of the set of directional perturbations Δp.

For example, the plurality of stacked feature maps 730M can include a total of M=9 feature maps, and can correspond to a set of eight different directional perturbations Δp. In some aspects, the value of M can represent the number of neighbors used in the flow-based propagation. The M=9 feature maps included in the plurality of stacked feature maps 730M can include the non-shifted, original target feature map 730 and can include eight replicas (e.g., copies or additional memory object instances, etc.) of the target feature map 730, where each respective replica is shifted (e.g., perturbed) by a different one of the eight different directional perturbations in Δp.

For each patch of a plurality of patches in the source feature map F₁ 710 (e.g., patch p₁ 712, patch p₂ 714, . . . , etc.), a corresponding flow query f_p₁, f_p₂, . . . , etc. (respectively) is performed for the warping operation of the randomized nearest neighbor technique. The number of flow queries can be equal to the number of patches in the source feature map F₁ 710, with each flow query corresponding to multiple memory R/W operations across the stack of the M=9 shifted feature maps 730M.

As used herein, the terms “flow query” and “query” may be used interchangeably to refer to the process of using a flow field to determine the corresponding position of a pixel, feature, or patch between first and second frames. For instance, a flow query can utilize an NNF or other flow field between the source feature map 710 and the stacked shifted target feature maps 730M to determine the corresponding position of a patch of the source feature map 710 within the stacked shifted target feature maps 730M.

For example, the flow query f_p₁ can use the NNF or other flow field to determine the corresponding position of patch 712 within the stack of shifted target feature maps 730M. The flow query f_p₂ can use the same NNF or other flow field to determine the corresponding position of patch 714 within the stack of shifted target feature maps 730M, . . . , etc. Each of the M replicas included in the stack of shifted target feature maps 730M is queried once per patch of the source feature map 710, per iteration of the feature map propagation 700 of FIG. 7.

In an example where the feature map propagation 700 of FIG. 7 corresponds to 2D propagation with a feature map size of H×W×C (e.g., number of pixels/patches in the height dimension, number of pixels/patches in the width dimension, and number of channels in the channel dimension), a number of neighbors M in propagation, and downsampling by a factor of 4 in height and width, the feature map memory requirement for warping is H×W×C×M.

The flow map memory requirement for warping is H×W×2, where the factor of 2 represents the horizontal and vertical displacements per patch during the warping. The feature size per flow query in warping (e.g., the channel size of the read) is equal to C×M, and represents the depth of the queried target feature map volume (e.g., the stacked shifted feature maps 730M) for each source frame 710 patch and each corresponding flow query. For example, the feature map memory requirement for warping is given by H×W×C×M, as noted above, and the “depth” of the queried target feature map volume 730M at each pixel/patch location within H×W is equal to C×M, which thus represents the feature size per flow query in warping.

The number of memory queries in warping is equal to H×W, based on a single flow query being performed for each of the H×W patch locations included in the source feature map 710.

The total feature memory required for warping using the feature map propagation 700 of FIG. 7 is equal to the feature map memory requirement for warping (e.g., H×W×C×M)+the flow map memory requirement for warping (e.g., H×W×2). For example, the total feature memory required for warping using the feature map propagation 700 of FIG. 7 is equal to HW (CM+2).

For a neighborhood radius size (e.g., propagation range) of r=2 (e.g., M=25), and using INT8 representations for {H, W, C, M}={480/4, 640/4, 256, 25}, the example feature map propagation 700 of FIG. 7 (e.g., which uses a stack of M shifted feature maps with a single flow query and multiple memory R/W across the stack of M shifted feature maps per patch of the source feature map) utilizes 122.9 MB of total feature memory for warping, and requires 19,200 flow queries.

FIG. 8 is a diagram illustrating an example of an enhanced feature map propagation technique 800, which can be implemented based on the stacking of M shifted feature flows (e.g., flow queries) between a source feature map F₁ 810 and a target feature map F₂ 830. In one illustrative example, the stacking of M shifted feature flows can represent the performance of multiple (e.g., M) flow queries on the single target feature map F₂ 830 for each patch of a plurality of patches includes in the source feature map F₁ 810.

In some aspects, the source feature map F₁ 810 of FIG. 8 can be the same as or similar to the source feature map F₁ 710 of FIG. 7 and/or the source frame 610 of FIG. 6. The target feature map F₂ 830 of FIG. 8 can be the same as or similar to the non-shifted target feature map F₂ 730 of FIG. 7 and/or the target frame 730 of FIG. 7. The source feature map F₁ 810 of FIG. 8 can include a first patch p₁ 812 that is the same as or similar to the first patch p₁ 712 of FIG. 7, a second patch p₂ 814 that is the same as or similar to the second patch p₂ of FIG. 8, . . . , etc.

Where the feature map propagation technique 700 of FIG. 7 can be used to perform feature map warping based on querying M target feature map memory replicas one time per source patch, the feature map propagation technique 800 of FIG. 8 can be used to perform feature map warping based on querying one target feature map memory replica M times per source patch.

In one illustrative example, the enhanced feature map propagation technique 800 of FIG. 8 can perform feature map warping with a memory space requirement that is a factor M smaller than the memory space requirement associated with the feature map propagation technique 700 of FIG. 7.

For instance, the feature map memory requirement for warping associated with the stacking of M copies (e.g., memory replicas) of shifted feature maps 730M of FIG. 7 is equal to H×W×C×M. The feature map memory requirement for warping associated with the stacking of M shifted feature flows for a single target feature map 830 of FIG. 8 is smaller by a factor of M, and is equal to H×W×C.

For example, the feature map propagation technique 800 of FIG. 8 can reduce the memory cost or memory requirement for warping when implementing flow-based propagation, where instead of stacking the multiple copies M of the shifted feature maps 730M (e.g., as in the feature map propagation technique 700 of FIG. 7), a single copy of the original feature map 830 is stored in memory and the feature map propagation technique 800 performs M times as many queries of shifted flows:

$$Corr = {F}_{1} \cdot {F}_{2}^{′}$$

F₂=W(F₂,S(f,Δp))

Δp={all combinations of directional perturbation}

For instance, the first feature patch p₁ 812 can correspond to a total of M=9 stacked and shifted flow queries from the source feature map F₁ 810 to the single target feature map F₂ 830. The set of M stacked and shifted flow queries performed per source feature patch corresponds to flow queries from the source feature patch to each respective target feature patch included in a virtually expanded neighborhood around a relative point (e.g., a center point) in the target feature map F₂ 830.

For instance, a center point in the target feature map F₂ 830 is represented as the patch ‘0’ in a first neighborhood 832 (e.g., which corresponds to the stacked and shifted flow queries f_p₁+Δp performed for the first source feature patch p₁ 812). The patch ‘0’ in a second neighborhood 834 represents the center point corresponding to the stacked and shifted flow queries f_p₂+Δp performed for the second source feature patch p₁ 814. For M=9, the first neighborhood 832 and the second neighborhood 834 each include a total of M=9 feature patches within the target feature map F₂ 830. As noted above, the feature patch ‘0’ in each neighborhood 832, 834 corresponds to a non-shifted flow query for the first source feature patch p₁ 812 and the second source feature patch p₂ 814 (respectively). The feature patches ‘1’, ‘2’, . . . , ‘8’ in each neighborhood 832, 834 correspond to the eight different shifted flow queries for the first source feature patch p₁ 812 and the second source feature patch p₂ 814 (respectively), where the shifted flow queries are shifted or perturbed according to the set of directional perturbations in Δp.

As noted previously, the enhanced feature map propagation technique 800 of FIG. 8 can perform feature map warping with a memory space requirement that is a factor M smaller than the memory space requirement associated with the feature map propagation technique 700 of FIG. 7.

For instance, the stacked flow query feature map propagation technique 800 of FIG. 8 can be associated with a feature map memory requirement for warping of H×W×C (e.g., decreased by a factor of M from the stacked target feature map technique of FIG. 7)

The flow map memory requirement for warping associated with the stacked flow queries of FIG. 8 can be equal to H×W×C×2 (e.g., increased by a factor of M from the stacked target feature map technique of FIG. 7), based on performing M warps per source feature patch rather than one warp per source feature patch as in FIG. 7. The number of memory queries in warping associated with the stacked flow queries of FIG. 8 can be equal to H×W×M, an increase of a factor of M from the stacked target feature map technique of FIG. 7 (e.g., also based on performing M flow queries per source feature patch rather than one flow query per source feature patch).

The feature size per query in warping can be equal to C, a reduction of a factor of M from the stacked target feature map technique of FIG. 7 (e.g., based on using a single target feature map F₂ 830 and not stacking M shifted replicas of the target feature map.

The total feature memory requirement for warping using the stacked flow queries of FIG. 8 can be equal to HW (C+2M). For a neighborhood radius size (e.g., propagation range) of r=2 (e.g., M=25), and using INT8 representations for {H, W, C, M}={480/4, 640/4, 256, 25}, the example feature map propagation 800 of FIG. 8 (e.g., which uses a stack of M shifted flow queries with a single target feature map F₂ 830) can utilize 5.9 MB of total feature memory for warping, and requires 480,000 flow queries.

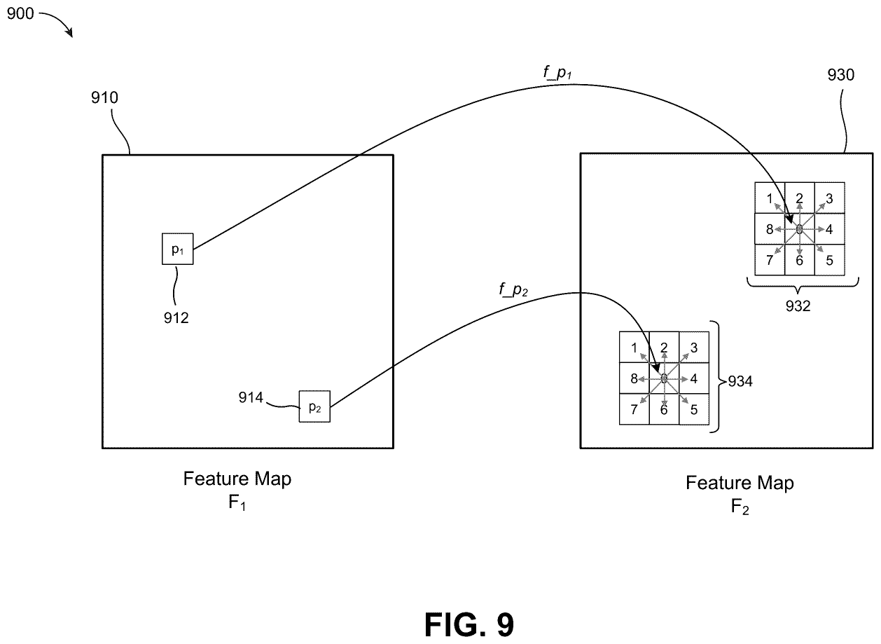

In one illustrative example, the systems and techniques can be used to perform flow-based propagation using virtual range expansion warping, without using multiple copies (e.g., memory replicas) of shifted and/or target feature maps and without using multiple stacked and/or shifted flow queries per feature patch of the source feature map. For example, FIG. 9 is a diagram illustrating an example of feature map propagation 900 using virtual range expansion warping, based on reading a neighborhood parch of features expanded around a flow query applied to a single copy of a feature map, in accordance with some examples.

In some aspects, the feature map propagation (e.g., virtual range expansion warping (VREW)) 900 of FIG. 9 can be used to perform flow-based propagation without using multiple stacked and/or shifted memory replicas of a target feature map (e.g., as in the example of FIG. 7, which utilizes M stacked and shifted target feature map memory replicas 730M). For example, the virtual range expansion warping 900 of FIG. 9 can be performed based on and using a single target feature map F₂ 930, which in some aspects can be the same as or similar to the target feature map F₂ 830 of FIG. 8, the non-shifted target feature map F₂ 730 of FIG. 7, and/or the target frame 630 of FIG. 6.

In some aspects, the virtual range expansion warping 900 of FIG. 9 can be used to perform flow-based propagation without using multiple stacked and/or shifted flow queries per feature patch of a source feature map (e.g., as in the example of FIG. 8, which utilizes M stacked and shifted flow queries per feature patch of the source feature map F₁ 810). For example, the virtual range expansion warping 900 of FIG. 9 can be performed based on and using a single flow query per feature patch of a source feature map F₁ 910, which in some examples can be the same as or similar to the source feature map F₁ 810 of FIG. 8, the source feature map F₁ 710 of FIG. 7, and/or the source frame 610 of FIG. 6. In some cases, the source feature map F₁ 910 can include a plurality of feature patches p₁ 912, p₂ 914, . . . , etc., which can be the same as or similar to the plurality of feature patches p₁ 812, p₂ 814, . . . , etc., (respectively) of FIG. 8 and/or the plurality of feature patches p₁ 712, p₂ 714, . . . , etc., (respectively) of FIG. 7.

In one illustrative example, the virtual range expansion warping 900 of FIG. 9 can be implemented using a single (e.g., original) copy or memory replica corresponding to the target feature map F₂ 930. For each source feature patch 912, 914, . . . , within the source feature map F₁ 910, a corresponding flow query can be performed to the target feature map F₂ 930. For example, the first feature patch p₁ 912 can be associated with a corresponding first flow query f_p₁ to the target feature map F₂ 930, the second feature patch p₂ 914 can be associated with a corresponding second flow query f_p₂ to the target feature map F₂ 930, . . . , etc.

In some aspects, when the respective flow query is performed for a particular feature patch of the source feature map F₁ 910, the systems and techniques are configured to read a patch of features (e.g., feature patches of the target feature map F₂ 930) expanded around the target within a configured virtual radius for correlation:

$$Corr = {F}_{1} \cdot {F}_{2}^{′}$$

F₂=Expand(W(F₂,f),r)

r=configured virtual radius for range expansion

In one illustrative example, the configured virtual radius r used to perform range expansion for the virtual range expansion warping can be indicative of a radius of neighboring patches within the target feature map F₂ 930 that are read during the flow query and read out of the center point (e.g., center patch or other relative point) corresponding to the source feature patch that is associated with the flow query.

For instance, each flow query can be based on a warping and/or flow-based propagation between a particular patch of the source feature map 910 (e.g., source feature patch 912, source feature patch 914, . . . ) and a particular patch of the target feature map 930.

For each flow query, a respective target patch ‘0’ can be configured as a relative point (e.g., a center point) of neighborhood of patches within the target feature map 930. For example, the neighborhood of target feature patches can comprise a configurable plurality (e.g., a configured quantity) of target feature patches that are each adjacent to the target patch center point ‘0’ and/or adjacent to one or more patches that are also included in the neighborhood.

In one illustrative example, the first source feature patch p₁ 912 can be associated with the first flow query f_p₁ and a corresponding first neighborhood 932 of target feature patches centered around the target patch center point ‘0’ of the first flow query f_p₁. The second source feature patch p₂ 914 can be associated with the second flow query f_p₂ and a corresponding second neighborhood 934 of target feature patches centered around the target patch center point ‘0’ of the second flow query f_p₂.

Each neighborhood 932, 934 can include a quantity M of target feature patches, where the neighborhood size M is based on the configured virtual radius r. For instance, for a configured virtual radius of r=1, each neighborhood 932, 934 has a size M=9 (e.g., the one target patch center point ‘0’+the eight adjacent patches ‘1’, ‘2’, . . . , ‘8’ that are within a radius of r=1 patch from the target patch center point ‘0’).

For a configured virtual radius of r=2, each neighborhood 932, 934 has a size M=25 (e.g., the center patch ‘0’+the 8 patches ‘1’-‘8’ with r=1 from the center point+the 16 patches ‘9’-‘24’ (not shown) with r=1 from the center point). For a configured virtual radius of r=3, each neighborhood 932, 934 can have a size of M=49, . . . , etc.

In some aspects, each flow query f_p₁, f_p₂, etc., can be configured to read a corresponding target patch center point ‘0’ of a respective neighborhood 932, 934, etc., and to further read a quantity M−1 neighborhood features expanded around the target patch ‘0’ within the configured virtual radius r for correlation. In one illustrative example, the target patch ‘0’ (e.g., neighborhood 932, 934 center point) and the patch of features expanded around the target (e.g., configured neighborhood patches ‘1’-‘8’) can be read out using the same (e.g., single) flow query f_p₁, f_p₂, . . . , and corresponding warping operation between the source feature map 910 and the target feature map 930.

In some aspects, a respective flow query f_p₁, f_p₂, . . . , can be configured to read out the target patch ‘0’ and the patch of neighborhood features expanded around the target (e.g., the neighborhood patches ‘1’-‘8’ within configured virtual radius r from the center patch ‘0’) simultaneously (e.g., in parallel). In some examples, a plurality of flow queries f_p₁, f_p₂, . . . can be performed in parallel between the source feature map 910 and the target feature map 930, where each flow query of the plurality of flow queries corresponds to a respective source patch, a respective target patch, and a respective neighborhood patch of features expanded around the respective target patch.

In one illustrative example, the virtual range expansion warping 900 of FIG. 9 is configured to perform a single flow query per feature patch of the source feature map F₁ 910, where the single flow query reads a target feature patch within the target feature map F₂ 930 (e.g., the ‘0’ feature patch) corresponding to the queried source feature patch, and additionally reads the M−1 neighboring feature patches that are located within the neighboring radius r of the target feature patch (e.g., the ‘1’-‘8’ feature patches in the neighborhood 932/934 centered around the ‘0’ feature patch).

As noted previously, a flow query may refer to a process of using a flow field to perform a look up or determination of the corresponding position (e.g., within a second feature map) of a pixel or feature patch within a first feature map. For example, performing a flow query f_p₁ for the feature patch p₁ 912 of the source feature map F₁ 910 may comprise determining a corresponding position of the feature patch p₁ 912 within the target feature map F₂ 930 (e.g., where the corresponding position of flow query f_p₁/feature patch p₁ 912 is the center point or target feature patch ‘0’ of the neighborhood 932).

In some aspects, a flow query can be performed to query the flow field to determine where a particular point (e.g., pixel, patch, etc.) in source feature map F₁ has moved to in the target feature map F₂. In one illustrative example, a flow query can be configured with an argument indicative of the source point within the source feature map F₁. For example, flow query f_p₁ can be configured with the source feature patch p₁, flow query f_p₂ can be configured with the source feature patch p₂, etc.

The corresponding flow vector for the source point can be determined using a lookup from the flow field. The flow vector can be indicative of the direction and magnitude of movement of the source point between its location in the source feature map F₁ and its location in the target feature map F₂.

Warping (e.g., flow warping) can be performed to warp or transform patches of source feature map F₁ based on the corresponding flow field and flow vector information for each patch. For example, a warping operation can be performed for each pixel or patch of the source feature map F₁, where the source feature patch is warped or transformed from a first position (e.g., within source feature map F₁) to a second position within target feature map F₂. The second position of the source feature patch, within target feature map F₂, can be referred to as a warped position or location for the source feature patch.

Warping can be a computationally expensive operation. In some cases, the respective flow vector for a point (e.g., pixel, patch, etc.) within the source feature map F₁ may point to a non-integer location in the target feature map F₂, where the non-integer location is not aligned with the pixel or patch grid dimensions of the target feature map F₂ but is instead located at a position between two or more pixels/patches. Various interpolation methods (e.g., bilinear or bicubic interpolation, etc.) may be used to estimate warped pixel values at the non-integer positions.

In one illustrative example, a center point or ‘0’ feature patch in the target feature map F₂ is the warped location corresponding to a particular flow query and source feature patch. For example, the ‘0’ center feature patch of neighborhood 932 is the warped location determined based on the source feature patch p₁ and the corresponding flow vector (e.g., included or represented within the flow query f_p₁) determined for the source feature patch p₁.

The flow query f_p₁ can be used to obtain or perform a readout of the feature(s) included in the ‘0’ center feature patch of neighborhood 932, as described above. To obtain the readout of the features of the neighborhood 932 feature patches ‘1’-′8′, the approach of FIG. 8 performs a separate flow query for each respective feature patch location within the neighborhood 932 (e.g., the flow query used to obtain the center patch ‘0’ is perturbed or shifted one patch to the left to query patch ‘8’, is perturbed or shifted one patch to the right to query patch ‘4’, is perturbed or shifted one patch down and one patch right to query patch ‘5’, . . . , etc.). In the approach of FIG. 8, performing each flow query requires one or more warping operations to be performed, and warping operations can be computationally expensive to perform, as noted above.

In one illustrative example, the systems and techniques described herein can be configured to implement virtual range expansion warping by modifying the readout associated with each flow query and/or warping operation. For instance, a warping engine may be used to implement the warping operations and flow queries between a first frame (e.g., source feature map F₁) and a second frame (e.g., target feature map F₂). The warping engine can be configured to implement an expanded readout operation for each warp, where the warping engine reads the feature/value corresponding to the warp center point ‘0’ patch and is additionally configured, as part of the same readout and same flow query warp operation, to read the respective features/values corresponding to each neighboring patch ‘1-‘8’ (e.g., in the example where the neighborhood size M=9 and/or the virtual radius r=1).

In some aspects, the virtual range expansion can be implemented based on configuring a warping engine to receive additional arguments associated with one or more flow queries and/or warping operations. For example, the additional arguments passed to the warping engine can be indicative of information and/or characteristics associated with the neighborhood 932, 934, etc., that is to be read in a combined flow query operation for the corresponding neighborhood center patch ‘0’. In some examples, the additional arguments passed to the warping engine may be indicative of one or more of the neighborhood size M and/or the virtual radius r for the virtual expanded range (e.g., neighborhood 932, 934, . . . ) of neighboring target feature patches that will be read in a combined flow query and warp operation with the center patch ‘0’.

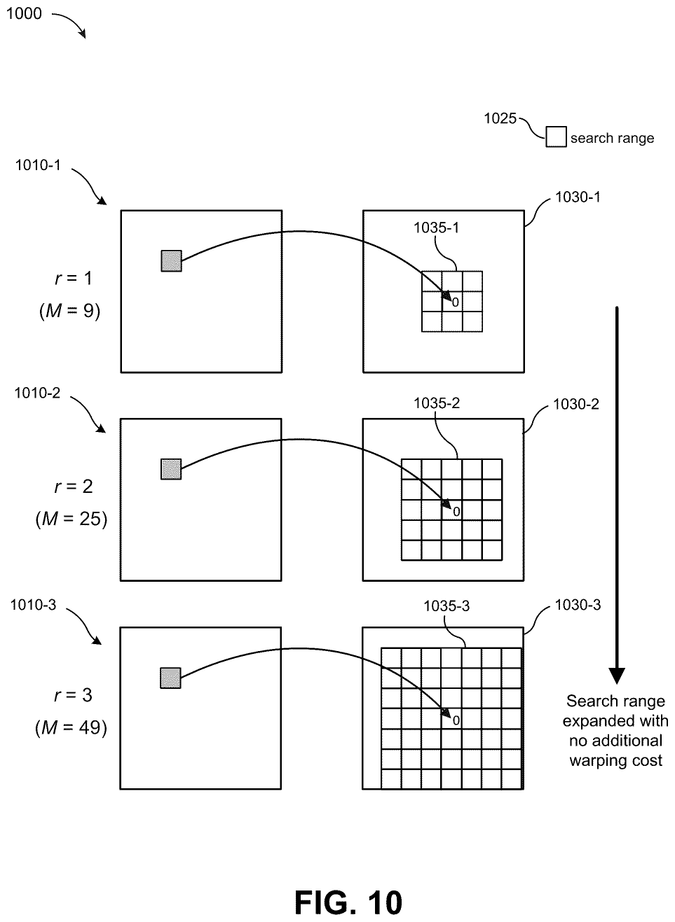

For example, FIG. 10 is a diagram illustrating an example of virtual range expansion warping 1000 for different values of the radius r (e.g., corresponding to different values of the neighborhood size M), in accordance with some examples. In one illustrative example, the virtual range expansion warping 1000 can be performed for different values of virtual radius r and neighborhood size M, where memory and query complexity associated with the feature propagation and/or flow warping is not a function of the neighborhood size M for the propagation range.

In a first range expansion configuration 1010-1, the virtual radius r=1, corresponding to a neighborhood size M=9. In a second range expansion configuration 1010-2, the virtual radius r=2, corresponding to a neighborhood size M=25. In a third range expansion configuration 1010-3, the virtual radius r=3, corresponding to a neighborhood size M=49.

In each of the three range expansion configurations 1010-1, 1010-2, 1010-3, a source feature map and source feature patch are shown on the left, and a corresponding target feature map 1030-1, 1030-2, 1030-3 (respectively) is shown on the right. The source feature maps of FIG. 10 can be the same as or similar to one or more of the source feature maps F₁ of FIGS. 6-9. The target feature maps 1030-1, 1030-2, 1030-3 of FIG. 10 can be the same as or similar to one or more of the target feature maps F₂ of FIGS. 6-9.

For each range expansion configuration examples 1010-1, 1010-2, 1010-3, a corresponding search range 1025 is represented as the shaded patches within the target feature map 1030-1, 1030-2, 1030-3 (respectively). For instance, the search range 1025 for the first configuration 1010-1 with r=1 (M=9) is the neighborhood 1035-1, which includes a center point feature patch ‘0’ and eight neighboring feature patches within radius r=1 of the center.

The search range for the second configuration 1010-2 with r=2 (M=25) is the neighborhood 1035-2, which includes the center point feature patch ‘0’ and 24 neighboring feature patches within radius r=2 of the center.

The search range for the third configuration 1010-3 with r=3 (M=49) is the neighborhood 1035-3, which includes the center point feature patch ‘0’ and 48 neighboring feature patches within radius r=3 of the center.

The neighborhood size M can be determined based on the configured radius r based on M=(2r+1)².

In one illustrative example, the systems and techniques described herein can be used to implement virtual range expansion warping (e.g., including the virtual range expansion warping of FIGS. 9 and/or 10) where the complexity in memory size and in the number of flow queries needed is not a function of the neighborhood size M for the propagation range. For instance, the three different virtual range expansion warping configurations 1010-1, 1010-2, 1010-3 can each be performed with the same memory usage and the same number of queries.

Table 1, presented below, depicts example complexity information corresponding to memory usage and flow query usage for the various techniques of FIGS. 6-10. Table 1 corresponds to an example of 2D propagation, where source and target feature maps have an original feature map size of H×W×C; the number of neighbors in propagation is M; and downsampling is performed by a factor of 4 in both height H and width W:

TABLE 1

| | M shifted | Single feature | Virtual Range Expansion |
|---|---|---|---|
| | feature maps & | map & M shifted | Warping (VREW): Single |
| | single flow | flow queries per | feature map & single flow |
| | query per patch | patch | query per patch |
| Feature map memory for warping | H × W × C × M | H × W × C | H × W × C |
| Flow map memory for warping | H × W × 2 | H × W × M × 2 | H × W × 2 |
| Feature size per flow query in warping | C × M | C | C × M |
| Number of memory queries in warping | H × W | H × W × M | H × W |
| Total feature memory for warping | HW(CM + 2) | HW(C + 2M) | HW(C + 2) |
| INT8 for $\{ H , W , C , M \} = \{ \frac{480}{4} , \frac{640}{4} , 256 , 25 \}$ | 122.9 MB for 19,200 queries | 5.9 MB for 480,000 queries | 5.0 MB for 19,200 queries |

Example complexity in memory usage and flow queries for different flow propagation techniques. The example corresponds to a 2D propagation with feature map size H × W × C, M neighbors in propagation for r = 2 (e.g., M = 25), 4x downsampling in height and width

In some aspects, the first column (e.g., ‘M shifted feature maps & single flow query per patch’) may correspond to the flow propagation techniques of FIGS. 6-7. The second column (e.g., ‘Single feature map & M shifted flow queries per patch) may correspond to the flow propagation technique(s) of FIG. 8. The third column (e.g., Virtual Range Expansion Warping (VREW): Single feature map & single flow query per patch’) may correspond to aspects of the present disclosure and/or the flow propagation technique(s) of FIG. 9 and/or FIG. 10.

As noted above, in one illustrative example, the systems and techniques described herein can perform flow propagation and/or virtual range expansion warping where complexity in memory size and number of flow queries is not a function of the neighbor size M for the propagation range. For example, the total feature memory associated with the virtual range expansion warping example of FIGS. 9 and/or 10 can be given by HW (C+2), which is a function only of the feature map dimensions H×W×C and has no dependency on the neighbor size M for the propagation range.

In one illustrative example, the systems and techniques described herein can perform flow propagation and/or virtual range expansion warping to allocate a virtually larger radius size (e.g., larger radius r and larger number of patches M for the neighborhood 1035-1, 1035-2, 1035-3, etc. queried by a single flow query) while keeping both the feature map memory size and the number of queries unaffected (e.g., constant).

For example, the first configuration 1010-1 with a virtual radius r=1 and neighborhood size M=9, the second configuration 1010-2 with a virtual radius r=2 and neighborhood size M=25, and the third configuration 1010-3 with a virtual radius r=3 and neighborhood size M=49 can each utilize the same total feature memory for warping given by HW (C+2), and can each perform the same number of memory queries in warping, given by H×W.

In one illustrative example, the systems and techniques described herein can be used to perform accelerated field and/or flow propagation, based on and/or using virtual range expansion warping. For example, the virtual range expansion (e.g., increasing the virtual radius r, which increases the neighborhood size M for each propagation iteration) can accelerate field or flow propagation based on a larger radius enabling faster propagation in terms of the number of iterations needed to reach convergence (or other threshold level of performance, accuracy, etc.). In some aspects, an output tensor of the virtual range expansion warping for a group of M neighbors at each pixel/patch coordinate of the target feature map F₂ can be sequentially expanded in dimension 1 into shape N×(CM)×H×W.

The systems and techniques described herein can be used to perform field and/or flow propagation with a smaller memory requirement for feature queries for warping. For instance, in some cases, the virtual range expansion warping can be associated with an order of magnitude smaller memory requirement than existing techniques and models for feature queries for warping. In some examples, field and/or flow propagation for warping operations may be implemented on resource-constrained devices such as smartphones, AR headsets, mobile computing devices, etc., which may utilize an NPU or NSP with relatively small vector tightly-coupled memory (VTCM). The systems and techniques can be used to implement field and/or flow propagation with virtual range expansion warping on resource-constrained devices, including resource-constrained devices that include NPUs or NSPs with relatively small VTCM sizes.

In some examples, the systems and techniques described herein can be used to perform field and/or flow propagation with a fewer number of flow queries needed in warping operations (e.g., grid sampling). In some cases, the total number of flow queries and warp operations for grid sampling and/or flow propagation may be the largest latency bottleneck in an NPU or NSP used to implement the field or flow propagation. The systems and techniques can be used to provide accelerated field or flow propagation based on reducing the number of flow queries and reducing the corresponding latency bottleneck associated with a larger number of flow queries.

In some aspects, the systems and techniques can be used to perform virtual expansion of the search range r in the target feature map, where the virtual expansion of the search range reduces the number of iterations of propagation or diffusion that are needed to achieve or reach convergence. Reducing the number of propagation or diffusion iterations can accelerate the field propagation (e.g., flow propagation, diffusion, etc.) operations.

The systems and techniques described herein for accelerated field propagation using virtual range expansion warping can be used for flow propagation, feature map warping, and/or diffusion, among various other techniques and models. In some cases, the virtual range expansion warping can be used to accelerate optical flow and/or various other iterative propagation computer vision (CV) tasks, as well as general diffusion tasks.

The systems and techniques described herein can be used to perform accelerated field propagation using virtual range expansion warping for 2D diffusion and/or propagation tasks, and 3D diffusion and/or propagation tasks (e.g., on videos for space and time, on 3D geometrics such as scene flow and 3DR, etc.). In some aspects, the systems and techniques can utilize and support arbitrary 2D and/or 3D kernel shapes for corresponding 2D/3D feature queries, in addition to utilizing and supporting square and cubic 2D/3D kernel shapes for feature queries.

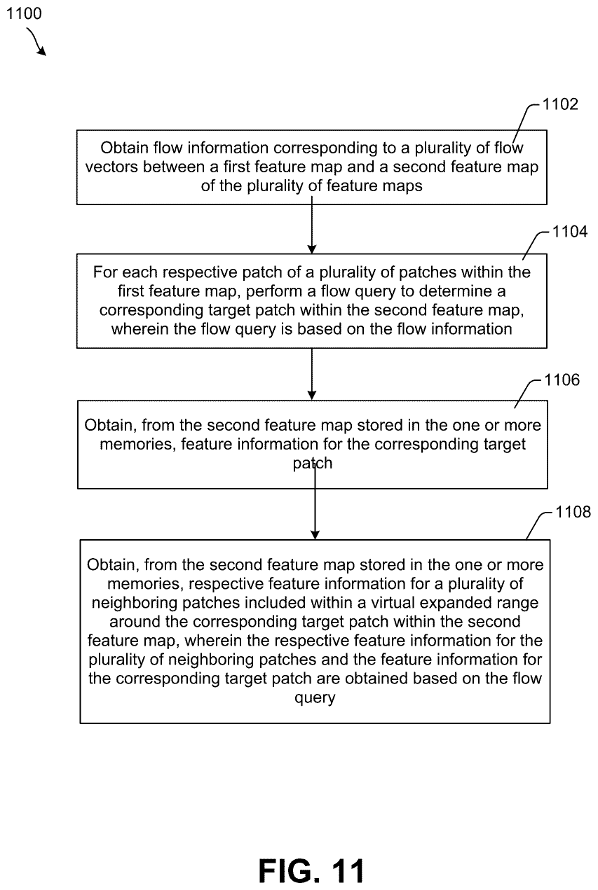

FIG. 11 is a flow chart illustrating an example of a process 1100 for image processing. For instance, the process 1100 can be a process for image processing using feature propagation. The process 1100 can be performed by a computing device or apparatus or a component or system (e.g., one or more chipsets, one or more processors such as one or more CPUs, DSPs, NPUs, NSPs, microcontrollers, ASICs, FPGAS, programmable logic devices, discrete gates or transistor logic components, discrete hardware components, etc., any combination thereof, and/or other component or system) of the computing device or apparatus. The operations of the process 1100 may be implemented as software components that are executed and run on one or more processors (e.g., processor 1210 of FIG. 12 or other processor(s)).

At block 1102, the computing device (or component thereof) can obtain flow information corresponding to a plurality of flow vectors between a first feature map and a second feature map of a plurality of feature maps. For example, the flow information can comprise a dense map of coordinate disparity information indicative of correspondence between the first feature map and the second feature map. In some cases, the flow information can be the same as or similar to the flow information associated with and between the source frame 610 of FIG. 6 as the first feature map and the target frame 630 of FIG. 6 as the second feature map.

In some cases, the first feature map can be the same as or similar to the feature map F₁ 710 of FIG. 7, 810 of FIG. 8, 910 of FIG. 9, 1010-1, 1010-2, 1010-3 of FIG. 10, etc. The second feature map can be the same as or similar to the F₂ and/or F₂′ feature maps 730M of FIG. 7, the F₂ feature map 830 of FIG. 8, 930 of FIG. 9, 1030-1, 1030-2, 1030-3 of FIG. 10, etc. The flow information can comprise one or more flow vectors, such as the flow vectors f_p₁, f_p₂ associated with FIGS. 7-10.

At block 1104, the computing device (or component thereof) can, for each respective patch of a plurality of patches within the first feature map, perform a flow query to determine a corresponding target patch within the second feature map, wherein the flow query is based on the flow information. For example, the flow query can be based on the flow initialization, flow propagation, and/or search of FIG. 6, can be based on the flow querying of FIG. 7-10, etc.

In some case, the corresponding target patch within the second feature map is configured as a current best match for feature propagation corresponding to the respective patch within the first feature map. For example, the corresponding target patch can be the patch ‘0’ of the feature map F₂ of FIG. 8, FIG. 9, FIG. 10, etc. In some examples, the computing device (or component thereof) is configured to perform feature propagation based on a similarity evaluation between feature information of the respective patch within the first feature map and the respective feature information obtained for the plurality of neighboring patches within the second feature map. For example, the plurality of neighboring patches can be the patches ‘1’-‘8’ in the neighborhood 832 around patch ‘0’ within the F₂ feature map 830 of FIG. 8 and/or the patches ‘1’-‘8’ in the neighborhood 834 around the patch ‘0’ within the F₂ feature map 830 of FIG. 8.

In some cases, to perform feature propagation, the computing device (or component thereof) can determine a particular neighboring patch of the plurality of neighboring patches has a greater similarity with the respective patch within the first feature map than the current best match, and can configure the particular neighboring patch as the current best match for feature propagation corresponding to the respective patch within the first feature map. In some examples, to perform one iteration of feature propagation, the computing device (or component thereof) can be configured to perform a single flow query for each respective patch of the plurality of patches within the first feature map, wherein a number of flow queries performed is not a function of the virtual expanded range and is not a function of a number of patches included in the plurality of neighboring patches.

In some examples, the computing device (or component thereof) can be configured to determine optical flow information corresponding to the first feature map and the second feature map, wherein the optical flow information is based on the feature propagation.

At block 1106, the computing device (or component thereof) can obtain, from the second feature map stored in the one or more memories, feature information for the corresponding target patch.

At block 1108, the computing device (or component thereof) can obtain, from the second feature map stored in the one or more memories, respective feature information for a plurality of neighboring patches included within a virtual expanded range around the corresponding target patch within the second feature map, wherein the respective feature information for the plurality of neighboring patches and the feature information for the corresponding target patch are obtained based on the flow query.

In some cases, a memory requirement for warping associated with the flow query is not a function of the virtual expanded range and is not a function of a number of patches included in the plurality of neighboring patches.

In some examples, the plurality of neighboring patches can be included within the virtual expanded range 932 around the first target patch ‘0’ in the second feature map F₂ 930 of FIG. 9, and/or can be include within the virtual expanded range 934 around the second target patch ‘0’ in the second feature map F₂ of FIG. 9. In some examples, the virtual expanded range can be the same as or similar to the virtual expanded range 1035-1, 1035-2, and/or 1035-3, etc., of FIG. 10.

In some cases, the respective feature information for the plurality of neighboring patches is obtained from a single memory replica of the second feature map stored by the one or more memories. For example, the second feature map 930 of FIG. 9 can comprise and/or be associated with a single memory replica stored in memory. In some examples, the respective feature information for the plurality of neighboring patches is obtained without using shifted memory replicas corresponding to the second feature map. For example, the respective feature information for the plurality of neighboring patches can be obtained without using shifted memory replicas the same as or similar to the shifted memory replicas 730M of FIG. 7 corresponding to the second feature map F₂ of FIG. 7, etc.

In some cases, the computing device (or component thereof) can be configured to determine the virtual expanded range based on a configured radius value and a location of the corresponding target patch within the second feature map. In some cases, the computing device (or component thereof) can be configured to determine the virtual expanded range based on a configured neighborhood size indicative of a number of patches included in the plurality of neighboring patches.

In some examples, each respective flow vector of the plurality of flow vectors is indicative of a displacement from a source patch within the first feature map to a target patch within the second feature map. In some cases, the computing device (or component thereof) can be configured to perform diffusion based on iterative propagation between the first feature map and the second feature map using the respective feature information for the plurality of neighboring patches included within the virtual expanded range.

In some examples, as noted previously, the processes described herein (e.g., process 1100 of FIG. 11, and/or other processes described herein) can be performed, in whole or in part, by a computing device or apparatus. In one example, one or more of the processes described herein can be performed by the image processing system 100, the image processing device 104, and/or the image capture device 102 of FIG. 1. In another example, one or more of the processes described herein can be performed by the system 200 of FIG. 2.

In another example, one or more of the processes (e.g., process 1100 of FIG. 11, and/or other processes described herein) can be performed, in whole or in part, by the computing-device architecture 1200 shown in FIG. 12. For instance, a computing device with the computing-device architecture 1200 shown in FIG. 12 can include, or be included in, the components of the image processing system 100, the image processing device 104, and/or the image capture device 102 of FIG. 1, the system 200 of FIG. 2, etc., and can implement the operations of process 1100 of FIG. 11, and/or other processes described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of a device configured to perform the process 1100 of FIG. 11 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 1100 is illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1100 and/or other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

In some aspects, training of one or more of the machine learning systems or neural networks described herein (e.g., a neural network implementing the diffusion process shown in FIG. 4, the U-Net machine learning architecture 500 of FIG. 5, among various other machine learning networks described with respect to FIGS. 6-10, etc.) can be performed using online training, offline training, and/or various combinations of online and offline training. In some cases, online may refer to time periods during which the input data (e.g., one or more of the feature maps described with respect to FIGS. 6-10, etc.) is processed, for instance for performance of the feature propagation using flow-based warping implemented by the systems and techniques described herein. In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

FIG. 12 illustrates an example computing-device architecture 1200 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1200 may include, implement, or be included in any or all of the image processing system 100, the image processing device 104, and/or the image capture device 102 of FIG. 1, the system 200 of FIG. 2, etc. Additionally or alternatively, computing-device architecture 1200 may be configured to perform process 1100 of FIG. 11, and/or other process described herein.

The components of computing-device architecture 1200 are shown in electrical communication with each other using connection 1212, such as a bus. The example computing-device architecture 1200 includes a processing unit (CPU or processor) 1202 and computing device connection 1212 that couples various computing device components including computing device memory 1210, such as read only memory (ROM) 1208 and random-access memory (RAM) 1206, to processor 1202.

Computing-device architecture 1200 can include a cache of high-speed memory connected directly with, in close proximity to, or integrated as part of processor 1202. Computing-device architecture 1200 can copy data from memory 1210 and/or the storage device 1214 to cache 1204 for quick access by processor 1202. In this way, the cache can provide a performance boost that avoids processor 1202 delays while waiting for data. These and other modules can control or be configured to control processor 1202 to perform various actions. Other computing device memory 1210 may be available for use as well. Memory 1210 can include multiple different types of memory with different performance characteristics. Processor 1202 can include any general-purpose processor and a hardware or software service, such as service 1 1216, service 2 1218, and service 3 1220 stored in storage device 1214, configured to control processor 1202 as well as a special-purpose processor where software instructions are incorporated into the processor design. Processor 1202 may be a self-contained system, containing multiple cores or processors, a bus, memory controller, cache, etc. A multi-core processor may be symmetric or asymmetric.

To enable user interaction with the computing-device architecture 1200, input device 1222 can represent any number of input mechanisms, such as a microphone for speech, a touch-sensitive screen for gesture or graphical input, keyboard, mouse, motion input, speech and so forth. Output device 1224 can also be one or more of a number of output mechanisms known to those of skill in the art, such as a display, projector, television, speaker device, etc. In some instances, multimodal computing devices can enable a user to provide multiple types of input to communicate with computing-device architecture 1200. Communication interface 1226 can generally govern and manage the user input and computing device output. There is no restriction on operating on any particular hardware arrangement and therefore the basic features here may easily be substituted for improved hardware or firmware arrangements as they are developed.

Storage device 1214 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1206, read only memory (ROM) 1208, and hybrids thereof. Storage device 1214 can include services 1216, 1218, and 1220 for controlling processor 1202. Other hardware or software modules are contemplated. Storage device 1214 can be connected to the computing device connection 1212. In one aspect, a hardware module that performs a particular function can include the software component stored in a computer-readable medium in connection with the necessary hardware components, such as processor 1202, connection 1212, output device 1224, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus to perform feature propagation, the apparatus comprising: one or more memories configured to store a plurality of feature maps; and one or more processors coupled to the one or more memories, the one or more processors being configured to: obtain flow information corresponding to a plurality of flow vectors between a first feature map and a second feature map of the plurality of feature maps; for each respective patch of a plurality of patches within the first feature map, perform a flow query to determine a corresponding target patch within the second feature map, wherein the flow query is based on the flow information; obtain, from the second feature map stored in the one or more memories, feature information for the corresponding target patch; and obtain, from the second feature map stored in the one or more memories, respective feature information for a plurality of neighboring patches included within a virtual expanded range around the corresponding target patch within the second feature map, wherein the respective feature information for the plurality of neighboring patches and the feature information for the corresponding target patch are obtained based on the flow query.

Aspect 2. The apparatus of Aspect 1, wherein: the corresponding target patch within the second feature map is configured as a current best match for feature propagation corresponding to the respective patch within the first feature map; and the one or more processors are configured to perform feature propagation based on a similarity evaluation between feature information of the respective patch within the first feature map and the respective feature information obtained for the plurality of neighboring patches within the second feature map

Aspect 3. The apparatus of Aspect 2, wherein, to perform feature propagation, the one or more processors are configured to: determine a particular neighboring patch of the plurality of neighboring patches has a greater similarity with the respective patch within the first feature map than the current best match; and configure the particular neighboring patch as the current best match for feature propagation corresponding to the respective patch within the first feature map.

Aspect 4. The apparatus of any of Aspects 1 to 3, wherein the one or more processors are configured to determine the virtual expanded range based on a configured radius value and a location of the corresponding target patch within the second feature map.

Aspect 5. The apparatus of any of Aspects 1 to 4, wherein the one or more processors are configured to determine the virtual expanded range based on a configured neighborhood size indicative of a number of patches included in the plurality of neighboring patches.

Aspect 6. The apparatus of any of Aspects 1 to 5, wherein a memory requirement for warping associated with the flow query is not a function of the virtual expanded range and is not a function of a number of patches included in the plurality of neighboring patches.

Aspect 7. The apparatus of any of Aspects 1 to 6, wherein, to perform one iteration of feature propagation, the one or more processors are configured to: perform a single flow query for each respective patch of the plurality of patches within the first feature map, wherein a number of flow queries performed is not a function of the virtual expanded range and is not a function of a number of patches included in the plurality of neighboring patches.

Aspect 8. The apparatus of any of Aspects 1 to 7, wherein the respective feature information for the plurality of neighboring patches is obtained from a single memory replica of the second feature map stored by the one or more memories.

Aspect 9. The apparatus of any of Aspects 1 to 8, wherein the respective feature information for the plurality of neighboring patches is obtained without using shifted memory replicas corresponding to the second feature map.

Aspect 10. The apparatus of any of Aspects 1 to 9, wherein the one or more processors are configured to determine optical flow information corresponding to the first feature map and the second feature map, wherein the optical flow information is based on the feature propagation.

Aspect 11. The apparatus of any of Aspects 1 to 10, wherein each respective flow vector of the plurality of flow vectors is indicative of a displacement from a source patch within the first feature map to a target patch within the second feature map.

Aspect 12. The apparatus of any of Aspects 1 to 11, wherein the one or more processors are configured to perform diffusion based on iterative propagation between the first feature map and the second feature map using the respective feature information for the plurality of neighboring patches included within the virtual expanded range.

Aspect 13. The apparatus of any of Aspects 1 to 12, wherein the flow information comprises a dense map of coordinate disparity information indicative of correspondence between the first feature map and the second feature map.

Aspect 14. The apparatus of any of Aspects 1 to 13, further comprising one or more cameras configured to capture respective images corresponding to the first feature map and the second feature map.

Aspect 15. The apparatus of Aspect 14, wherein the one or more processors are configured to: generate one or more output images corresponding to the respective images, wherein the one or more output images are generated based on iterative feature propagation using the virtual expanded range.

Aspect 16. The apparatus of Aspect 15, further comprising one or more displays configured to display the one or more output images.

Aspect 17. The apparatus of any of Aspects 14 to 16, wherein the one or more processors are configured to perform one or more of optical flow estimation, depth estimation, or motion estimation between the first feature map and the second feature map, based on iterative feature propagation using the virtual expanded range.

Aspect 18. A method for feature propagation, comprising: obtaining flow information corresponding to a plurality of flow vectors between a first feature map and a second feature map of the plurality of feature maps; for each respective patch of a plurality of patches within the first feature map, performing a flow query to determine a corresponding target patch within the second feature map, wherein the flow query is based on the flow information; obtaining, from the second feature map stored in the one or more memories, feature information for the corresponding target patch; and obtaining, from the second feature map stored in the one or more memories, respective feature information for a plurality of neighboring patches included within a virtual expanded range around the corresponding target patch within the second feature map, wherein the respective feature information for the plurality of neighboring patches and the feature information for the corresponding target patch are obtained based on the flow query.

Aspect 19. The method of Aspect 18, wherein: the corresponding target patch within the second feature map is configured as a current best match for feature propagation corresponding to the respective patch within the first feature map; and the method further comprises performing feature propagation based on a similarity evaluation between feature information of the respective patch within the first feature map and the respective feature information obtained for the plurality of neighboring patches within the second feature map

Aspect 20. The method of Aspect 19, wherein performing feature propagation comprises: determining a particular neighboring patch of the plurality of neighboring patches has a greater similarity with the respective patch within the first feature map than the current best match; and configuring the particular neighboring patch as the current best match for feature propagation corresponding to the respective patch within the first feature map.

Aspect 21. The method of any of Aspects 18 to 20, further comprising determining the virtual expanded range based on a configured radius value and a location of the corresponding target patch within the second feature map.

Aspect 22. The method of any of Aspects 18 to 21, further comprising determining the virtual expanded range based on a configured neighborhood size indicative of a number of patches included in the plurality of neighboring patches.

Aspect 23. The method of any of Aspects 18 to 22, wherein a memory requirement for warping associated with the flow query is not a function of the virtual expanded range and is not a function of a number of patches included in the plurality of neighboring patches.

Aspect 24. The method of any of Aspects 18 to 23, wherein performing one iteration of feature propagation comprises: performing a single flow query for each respective patch of the plurality of patches within the first feature map, wherein a number of flow queries performed is not a function of the virtual expanded range and is not a function of a number of patches included in the plurality of neighboring patches.

Aspect 25. The method of any of Aspects 18 to 24, wherein the respective feature information for the plurality of neighboring patches is obtained from a single memory replica of the second feature map stored by the one or more memories.

Aspect 26. The method of any of Aspects 18 to 25, wherein the respective feature information for the plurality of neighboring patches is obtained without using shifted memory replicas corresponding to the second feature map.

Aspect 27. The method of any of Aspects 18 to 26, further comprising determining optical flow information corresponding to the first feature map and the second feature map, wherein the optical flow information is based on the feature propagation.

Aspect 28. The method of any of Aspects 18 to 27, wherein each respective flow vector of the plurality of flow vectors is indicative of a displacement from a source patch within the first feature map to a target patch within the second feature map.

Aspect 29. The method of any of Aspects 18 to 28, further comprising performing diffusion based on iterative propagation between the first feature map and the second feature map using the respective feature information for the plurality of neighboring patches included within the virtual expanded range.

Aspect 30. The method of any of Aspects 18 to 29, wherein the flow information comprises a dense map of coordinate disparity information indicative of correspondence between the first feature map and the second feature map.

Aspect 31. The method of any of Aspects 18 to 30, further comprising generating one or more output images corresponding to respective images captured by one or more cameras and corresponding to the first feature map and the second feature map, wherein the one or more output images are generated based on iterative feature propagation using the virtual expanded range.

Aspect 32. The method of any of Aspects 18 to 31, further comprising performing one or more of optical flow estimation, depth estimation, or motion estimation between the first feature map and the second feature map, based on iterative feature propagation using the virtual expanded range.

Aspect 33. A non-transitory computer-readable storage medium comprising instructions stored thereon which, when executed by at least one processor, causes the at least one processor to perform operations according to any of Aspects 1 to 17.

Aspect 34. A non-transitory computer-readable storage medium comprising instructions stored thereon which, when executed by at least one processor, causes the at least one processor to perform operations according to any of Aspects 18 to 32.

Aspect 35. An apparatus comprising one or more means for performing operations according to any of Aspects 1 to 17.

Aspect 36. An apparatus comprising one or more means for performing operations according to any of Aspects 18 to 32.

What is claimed is:

1. An apparatus to perform feature propagation, the apparatus comprising:
one or more memories configured to store a plurality of feature maps; and
one or more processors coupled to the one or more memories, the one or more processors being configured to:
obtain flow information corresponding to a plurality of flow vectors between a first feature map and a second feature map of the plurality of feature maps;
for each respective patch of a plurality of patches within the first feature map, perform a flow query to determine a corresponding target patch within the second feature map, wherein the flow query is based on the flow information;
obtain, from the second feature map stored in the one or more memories, feature information for the corresponding target patch; and
obtain, from the second feature map stored in the one or more memories, respective feature information for a plurality of neighboring patches included within a virtual expanded range around the corresponding target patch within the second feature map, wherein the respective feature information for the plurality of neighboring patches and the feature information for the corresponding target patch are obtained based on the flow query.

2. The apparatus of claim 1, wherein:
the corresponding target patch within the second feature map is configured as a current best match for feature propagation corresponding to the respective patch within the first feature map; and
the one or more processors are configured to perform feature propagation based on a similarity evaluation between feature information of the respective patch within the first feature map and the respective feature information obtained for the plurality of neighboring patches within the second feature map.

3. The apparatus of claim 2, wherein, to perform feature propagation, the one or more processors are configured to:
determine a particular neighboring patch of the plurality of neighboring patches has a greater similarity with the respective patch within the first feature map than the current best match; and
configure the particular neighboring patch as the current best match for feature propagation corresponding to the respective patch within the first feature map.

4. The apparatus of claim 1, wherein the one or more processors are configured to determine the virtual expanded range based on a configured radius value and a location of the corresponding target patch within the second feature map.

5. The apparatus of claim 1, wherein the one or more processors are configured to determine the virtual expanded range based on a configured neighborhood size indicative of a number of patches included in the plurality of neighboring patches.

6. The apparatus of claim 1, wherein a memory requirement for warping associated with the flow query is not a function of the virtual expanded range and is not a function of a number of patches included in the plurality of neighboring patches.

7. The apparatus of claim 1, wherein, to perform one iteration of feature propagation, the one or more processors are configured to:
perform a single flow query for each respective patch of the plurality of patches within the first feature map,
wherein a number of flow queries performed is not a function of the virtual expanded range and is not a function of a number of patches included in the plurality of neighboring patches.

8. The apparatus of claim 1, wherein the respective feature information for the plurality of neighboring patches is obtained from a single memory replica of the second feature map stored by the one or more memories.

9. The apparatus of claim 1, wherein the respective feature information for the plurality of neighboring patches is obtained without using shifted memory replicas corresponding to the second feature map.

10. The apparatus of claim 1, wherein the one or more processors are configured to determine optical flow information corresponding to the first feature map and the second feature map, wherein the optical flow information is based on the feature propagation.

11. The apparatus of claim 1, wherein each respective flow vector of the plurality of flow vectors is indicative of a displacement from a source patch within the first feature map to a target patch within the second feature map.

12. The apparatus of claim 1, wherein the one or more processors are configured to perform diffusion based on iterative propagation between the first feature map and the second feature map using the respective feature information for the plurality of neighboring patches included within the virtual expanded range.

13. The apparatus of claim 1, wherein the flow information comprises a dense map of coordinate disparity information indicative of correspondence between the first feature map and the second feature map.

14. The apparatus of claim 1, further comprising one or more cameras configured to capture respective images corresponding to the first feature map and the second feature map.

15. The apparatus of claim 14, wherein the one or more processors are configured to:
generate one or more output images corresponding to the respective images, wherein the one or more output images are generated based on iterative feature propagation using the virtual expanded range.

16. The apparatus of claim 15, further comprising one or more displays configured to display the one or more output images.

17. The apparatus of claim 14, wherein the one or more processors are configured to perform one or more of optical flow estimation, depth estimation, or motion estimation between the first feature map and the second feature map, based on iterative feature propagation using the virtual expanded range.

18. A method for feature propagation, comprising:
obtaining flow information corresponding to a plurality of flow vectors between a first feature map and a second feature map of a plurality of feature maps;
for each respective patch of a plurality of patches within the first feature map, performing a flow query to determine a corresponding target patch within the second feature map, wherein the flow query is based on the flow information;
obtaining, from the second feature map, feature information for the corresponding target patch; and
obtaining, from the second feature map, respective feature information for a plurality of neighboring patches included within a virtual expanded range around the corresponding target patch within the second feature map, wherein the respective feature information for the plurality of neighboring patches and the feature information for the corresponding target patch are obtained based on the flow query.

19. The method of claim 18, wherein:
the corresponding target patch within the second feature map is configured as a current best match for feature propagation corresponding to the respective patch within the first feature map; and
the method further comprises performing feature propagation based on a similarity evaluation between feature information of the respective patch within the first feature map and the respective feature information obtained for the plurality of neighboring patches within the second feature map.

20. The method of claim 19, wherein performing feature propagation comprises:
determining a particular neighboring patch of the plurality of neighboring patches has a greater similarity with the respective patch within the first feature map than the current best match; and
configuring the particular neighboring patch as the current best match for feature propagation corresponding to the respective patch within the first feature map.
